(19) United States
(12) Patent Application Publication
(10) Pub. No.: US 2023/0177713 A1
(43) Pub. Date: Jun. 8, 2023

(54) INFORMATION PROCESSING APPARATUS, INFORMATION PROCESSING METHOD, AND PROGRAM

(71) Applicant: SONY GROUP CORPORATION, TOKYO (JP)

(72) Inventors: MASATOSHI YOKOKAWA, TOKYO (JP); TOMOHIRO NISHI, TOKYO (JP)

(21) Appl. No.: 17/906,683

(22) PCT Filed: Mar. 16, 2021
(86) PCT No.: PCT/JP2021/010620

§ 371 Date: Sep. 19, 2022

(30) Foreign Application Priority Data
Mar. 27, 2020 (JP) 2020-058958

(51) Int. Cl. G06T 7/593; G06T 5/50; G06V 10/74; H04N 1/60; H04N 13/15; H04N 23/11

(52) U.S. Cl. CPC G06T 7/593; G06T 5/50; G06V 10/761; H04N 1/60; H04N 13/15; H04N 23/11; G06T 2207/10048; G06T 2207/10144; G06T 2207/20221

(57) ABSTRACT

An information processing apparatus (IP1) includes a depth information extraction unit (DIE1) and a processing unit (IMP). The depth information extraction unit (DIE1) can extract depth information from a plurality of pieces of infrared image information included in a plurality of pieces of image data. The plurality of pieces of image data is image data captured from a plurality of viewpoints. Each of the plurality of pieces of image data includes visible light image information and infrared image information. Based on the depth information, the processing unit (IMP) processes the visible light image generated using the visible light image information included in at least one piece of image data among the plurality of pieces of image data.

### FIELD

The present invention relates to an information processing apparatus, an information processing method, and a program.

### BACKGROUND

There is a known technology referred to as a stereo image technology of extracting depth information regarding a subject using parallax information. A product using the stereo image technology is generally referred to as a stereo camera. The stereo imaging includes a passive stereo method and an active stereo method. The passive stereo method is a method of extracting depth information using parallax information regarding a plurality of visible light images. The active stereo method is a method of extracting depth information using parallax information regarding a plurality of infrared images obtained by capturing an infrared projection pattern (refer to Patent Literatures 1 and 2, for example).

### CITATION LIST

### Patent Literature

Patent Literature 1: JP 2008-275366 A

Patent Literature 2: WO 2007/043036 A

### SUMMARY

### Technical Problem

The stereo imaging needs to determine corresponding points between two images. The active stereo method is a method in which an infrared projection pattern is projected on a subject, making it easier to determine corresponding points as compared with the passive stereo method. However, an image captured by the active stereo method includes an infrared projection pattern. This makes it difficult to use the captured image as it is as an image for viewing. It is conceivable to separately install a camera for viewing. However, there is a position shift due to parallax occurring between the depth map generated using depth information and the image for viewing. This makes it difficult to perform image processing (foreground/background separation, refocusing, relighting, and the like) using the depth map.

In view of this, the present disclosure proposes an information processing apparatus, an information processing method, and a program capable of easily performing image processing using depth information.

### Solution to Problem

According to the present disclosure, an information processing apparatus is provided that comprises: a depth information extraction unit capable of extracting depth information from a plurality of pieces of infrared image information included in a plurality of pieces of image data captured at a plurality of viewpoints, the plurality of pieces of image data each including visible light image information and infrared image information; and a processing unit that processes, based on the depth information, a visible light image generated by using the visible light image information included in at least one piece of image data among the plurality of pieces of image data. According to the present disclosure, an information processing method in which an information process of the information processing apparatus is executed by a computer, and a program for causing the computer to execute the information process of the information processing apparatus, are provided.

### BRIEF DESCRIPTION OF DRAWINGS

FIG. 1 is a schematic diagram of an information processing apparatus according to a first embodiment.

FIG. 2 is a schematic view of a camera.

FIG. 3 is a diagram illustrating an example of a configuration of an image sensor.

FIG. 4 is a conceptual diagram of information processing.

FIG. 5 is a flowchart illustrating an information processing method.

FIG. 6 is a schematic diagram of an information processing apparatus according to a second embodiment.

FIG. 7 is a conceptual diagram of information processing.

FIG. 8 is a flowchart illustrating an information processing method.

FIG. 9 is a schematic diagram of an information processing apparatus according to a third embodiment.

FIG. 10 is a conceptual diagram of information processing.

FIG. 11 is a flowchart illustrating an information processing method.

FIG. 12 is a schematic diagram of an information processing apparatus according to a fourth embodiment.

FIG. 13 is a conceptual diagram of information processing.

FIG. 14 is a flowchart illustrating an information processing method.

FIG. 15 is a schematic diagram of an information processing apparatus according to a fifth embodiment.

FIG. 16 is a diagram illustrating a variation of the pixel array unit.

FIG. 17 is a diagram illustrating a variation of the pixel array unit.

FIG. 18 is a diagram illustrating a variation of the pixel array unit.

FIG. 19 is a diagram illustrating a variation of the pixel array unit.

FIG. 20 is a diagram illustrating a variation of the pixel array unit.

FIG. 21 is a diagram illustrating a variation of the pixel array unit.

FIG. 22 is a schematic diagram of an information processing apparatus according to a sixth embodiment.

FIG. 23 is a view illustrating a relationship between an infrared transmission amount and an exposure period for the first camera and the second camera.

FIG. 24 is a diagram illustrating visible light exposure amounts for the first camera and the second camera.

FIG. 25 is a view illustrating a perspective projection model.

FIG. 26 is a diagram illustrating a warping process.

FIG. 27 is a conceptual diagram of a combining process.

FIG. 28 is a conceptual diagram of information processing.

FIG. 29 is a flowchart illustrating an information processing method.

FIG. 30 is a schematic diagram of an information processing apparatus according to a seventh embodiment.

FIG. 31 is a view for describing a method of applying blur (degradation) to a dot pattern.

FIG. 32 is a view for describing a method of applying blur (degradation) to a dot pattern.

FIG. 33 is a diagram illustrating a correction process.

FIG. 34 is a diagram illustrating an example of a method of calculating a color conversion matrix.

FIG. 35 is a conceptual diagram of information processing.

FIG. 36 is a flowchart illustrating an information processing method.

FIG. 37 is a schematic diagram of an information processing apparatus according to an eighth embodiment.

FIG. 38 is a conceptual diagram of information processing.

FIG. 39 is a flowchart illustrating an information processing method.

### DESCRIPTION OF EMBODIMENTS

Embodiments of the present disclosure will be described below in detail with reference to the drawings. In each of the following embodiments, the same parts are denoted by the same reference symbols, and a repetitive description thereof will be omitted.

Note that the description will be given in the following order.

[1. First Embodiment]

[1-1. Configuration of information processing apparatus]

[1-2. Information processing method]

[1-3. Effects]

[2. Second Embodiment]

[2-1. Configuration of information processing apparatus]

[2-2. Information processing method]

[2-3. Effects]

[3. Third Embodiment]

[3-1. Configuration of information processing apparatus]

[3-2. Information processing method]

[3-3. Effects]

[4. Fourth Embodiment]

[4-1. Configuration of information processing apparatus]

[4-2. Information processing method]

[4-3. Effects]

[5. Fifth Embodiment]

[6. Variations of pixel array unit]

[7. Sixth Embodiment]

[7-1. Configuration of information processing apparatus]

[7-2. Information processing method]

[7-3. Effects]

[8. Seventh Embodiment]

[8-1. Configuration of information processing apparatus]

[8-2. Information processing method]

[8-3. Effect]

[9. Eighth Embodiment]

[9-1. Configuration of information processing apparatus]

[9-2. Information processing method]

[9-3. Effects]

### 1. First Embodiment

[1-1. Configuration of Information Processing Apparatus]

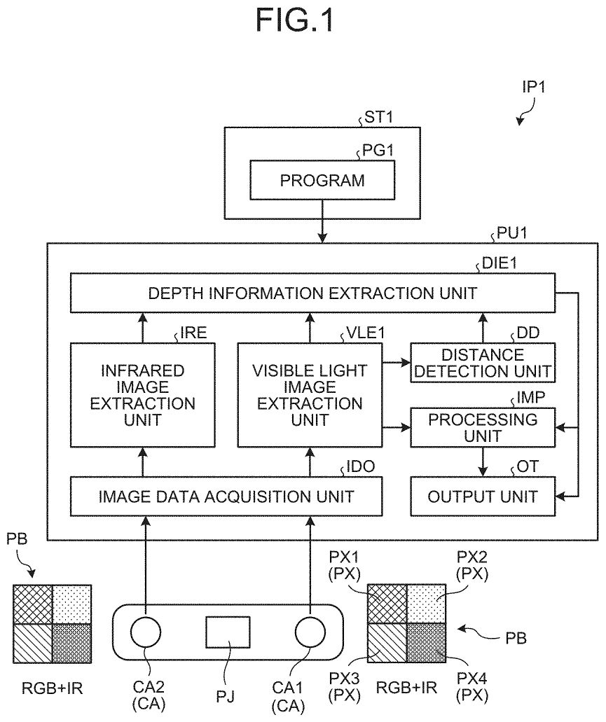

FIG. 1 is a schematic diagram of an information processing apparatus IP1 according to a first embodiment. The information processing apparatus IP1 is, for example, a stereo camera.

The information processing apparatus IP1 includes, for example, a processing device PU1, a plurality of cameras CA, a projector PJ, and a storage device ST1.

The processing device PU1 is a device that extracts depth information and performs image processing using a plurality of pieces of image data acquired from the plurality of cameras CA. The image processing includes, for example, foreground/background separation, refocusing, and relighting. The foreground/background separation is processing of separating the foreground and the background from each other. The refocusing is processing of adjusting a focus only on a designated portion so that a foreground subject or the like stands out from the background. The relighting is processing of adjusting the brightness of a designated portion so that a foreground subject or the like stands out from the background. The image processing is performed based on depth information.

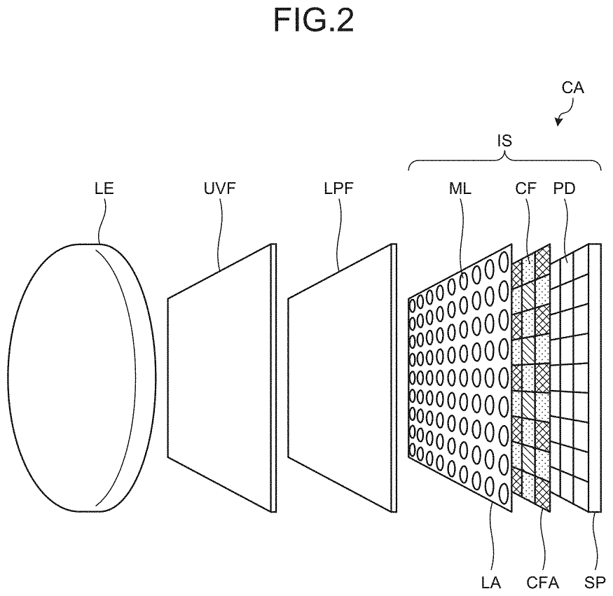

FIG. 2 is a schematic diagram of the camera CA.

The camera CA includes a lens LE, a UV cut filter UVF, a low-pass filter LPF, and an image sensor IS. The UV cut filter UVF cuts ultraviolet light. The low-pass filter LPF passes only light having a wavelength necessary as image information and cuts other light. The low-pass filter LPF intentionally blurs the image captured by the lens LE to suppress the occurrence of moire and false color.

The image sensor IS converts light incident from the lens LE into an electric signal. The image sensor IS includes a lens array LA, a color filter array CFA, and a sensor plate SP, for example. The sensor plate SP includes a plurality of light source conversion elements (photodiodes) PD arranged two-dimensionally. The light source conversion element PD photoelectrically converts a charge amount corresponding to the amount of incident light so as to be accumulated inside the element and to be output as a signal. The color filter array CFA includes a plurality of color filters CF provided in one-to-one correspondence with the plurality of photodetectors PD. The lens array LA includes a plurality of microlenses ML that condense light incident from the lens LE onto the plurality of photodetectors PD.

Examples of applicable image sensors IS include a complementary metal oxide semiconductor (CMOS) image sensor and a charge-coupled device (CCD) image sensor. Examples of applicable color filter arrays CFA include a primary color filter array and a complementary color filter array. The primary color filter array includes color filters CF of three colors of red, green, and blue. The complementary color filter array includes color filters CF of four colors of cyan, yellow, magenta, and green. In the present embodiment, a CMOS image sensor using a primary color filter array is used. The camera CA is used in a wide range of applications such as in-vehicle use.

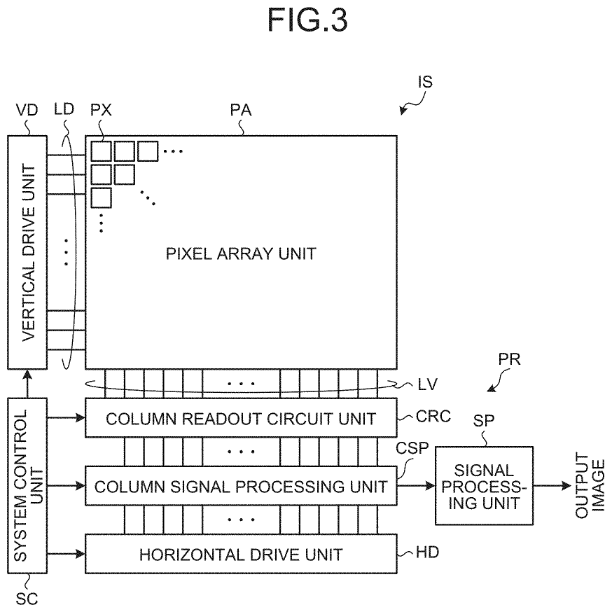

FIG. 3 is a diagram illustrating an example of a configuration of the image sensor IS.

The image sensor IS includes a pixel array unit PA, a vertical drive unit VD, a column readout circuit unit CRC, a column signal processing unit CSP, a horizontal drive unit HD, a system control unit SC, and a signal processing unit SP. The pixel array unit PA, the vertical drive unit VD, the column readout circuit unit CRC, the column signal processing unit CSP, the horizontal drive unit HD, the system control unit SC, and the signal processing unit SP are implemented by a processing circuit PR such as an integrated circuit (IC) formed in the sensor plate SP, for example.

The pixel array unit PA includes a plurality of pixels PX arranged two-dimensionally. The pixel PX includes a photoelectric conversion element PD and a color filter CF. In the pixel array unit PA, a plurality of pixel drive lines LD extending in a horizontal direction (row direction being a right-left direction in the drawing) and a plurality of vertical pixel wiring lines LV extending in a vertical direction (column direction being an up-down direction in the drawing) are provided in a grid pattern. The pixel drive line LD is provided for each pixel row extending in the horizontal direction. The vertical pixel wiring line LV is provided for each pixel column extending in the vertical direction. One end of the pixel drive line LD is connected to an output terminal corresponding to each of rows of the vertical drive unit VD.

The column readout circuit unit CRC includes at least a circuit that supplies a constant current to the pixel PX in the selected row in the pixel array unit PA for each column, a current mirror circuit, and a switching switch of the pixel PX as a readout target. The column readout circuit unit CRC constitutes an amplifier together with a transistor in a selected pixel in the pixel array unit PA, converts a photo-charge signal into a voltage signal, and outputs the voltage signal to the vertical pixel wiring line LV.

The vertical drive unit VD includes a shift register, an address decoder, and the like. The vertical drive unit VD drives each pixel PX of the pixel array unit PA in units of rows. Although a specific configuration is not illustrated, the vertical drive unit VD has a configuration including a readout scanning system, a sweep-out scanning system or a batch sweep-out, and a batch transfer system.

In order to read a pixel signal from the pixel PX, the readout scanning system sequentially performs selective scanning on the pixel PX of the pixel array unit PA in units of rows. In the case of sweep-out in row driving (rolling shutter operation), sweep-out scanning is performed on a readout row on which readout scanning is performed by the readout scanning system prior to the readout scanning by a time corresponding to a shutter speed. In the case of global exposure (global shutter operation), batch sweep-out is performed prior to the batch transfer by the time of the shutter speed. By such sweep-out, unnecessary charges are swept (reset) from the photodiodes PD of the pixels PX in the readout row. By execution of sweep-out (resetting) of unnecessary charges, an operation referred to as an electronic shutter operation is performed.

Here, the electronic shutter operation refers to an operation of discarding unnecessary photo-charges accumulated in the photodiode PD until immediately before the operation and newly starting exposure (starting accumulation of photo-charges).

The signal read out by the readout operation by the readout scanning system corresponds to the amount of light incident after the immediately preceding readout operation or electronic shutter operation. In the case of row driving, a period from the readout timing by the immediately preceding readout operation or the sweep-out timing of the electronic shutter operation to the readout timing of the present readout operation corresponds to a photo-charge accumulation period (exposure period) in the pixel PX. In the case of global exposure, the time from batch sweep-out to batch transfer is the accumulation period (exposure period).

The pixel signal output from each pixel PX of the pixel row selectively scanned by the vertical drive unit VD is supplied to the column signal processing unit CSP through each of the vertical pixel wiring lines LV. The column signal processing unit CSP performs predetermined signal processing on the signal output from each pixel PX of the selected row through the vertical pixel wiring line LV for each of the pixel columns of the pixel array unit PA, and temporarily holds the pixel signal that has undergone the signal processing.

Specifically, the column signal processing unit CSP performs at least noise removal processing, for example, correlated double sampling (CDS) processing as the signal processing. The CDS performed by the column signal processing unit CSP removes fixed pattern noise unique to the pixel, such as reset noise and the threshold variation of an amplification transistor AMP. The column signal processing unit CSP can be configured to have an AD conversion function in addition to the noise removal processing so as to output a pixel signal as a digital signal.

The horizontal drive unit HD includes a shift register, an address decoder, and the like. The horizontal drive unit HD sequentially selects a unit circuit corresponding to a pixel column of the column signal processing unit CSP. With the selective scanning by the horizontal drive unit HD, the pixel signals that have undergone the signal processing by the column signal processing unit CSP are sequentially output to the signal processing unit SP.

The system control unit SC includes devices such as a timing generator that generates various timing signals. The system control unit SC performs drive control of the vertical drive unit VD, the column signal processing unit CSP, the horizontal drive unit HD, and the like based on various timing signals generated by the timing generator.

The image sensor IS further includes a signal processing unit SP and a data storage unit (not illustrated). The signal processing unit SP has at least an addition processing function, and performs various signal processing such as addition processing on the pixel signal output from the column signal processing unit CSP. The data storage unit temporarily stores data necessary for processing in the signal processing performed by the signal processing unit SP. The processing of the signal processing unit SP and the data storage unit may be substituted by an external signal processing unit provided on a substrate different from the image sensor IS, for example, by a digital signal processor (DSP) or software.

Returning to FIG. 1, the plurality of cameras CA is installed at a position different from each other. Therefore, the positions of the viewpoints of the plurality of cameras CA at the time of capturing the subject are different from each other. The plurality of cameras CA outputs image data captured from a plurality of viewpoints to the processing device PU1. In the example of FIG. 1, the plurality of cameras CA include a first camera CA1 and a second camera CA2. The first camera CA1 and the second camera CA2 are installed at symmetrical positions about the projector PJ.

The camera CA includes the image sensor IS capable of detecting both visible light and infrared. The image sensor IS has a structure, for example, in which a plurality of pixels PX for detecting visible light image information and a plurality of pixels PX for detecting infrared image information are periodically arranged in a two-dimensional direction. For example, the image sensor IS includes a plurality of pixel blocks PB arranged two-dimensionally. For example, the pixel block PB has a structure in which one pixel PX1 for detecting red light, one pixel PX2 for detecting green light, one pixel PX3 for detecting blue light, and one pixel PX4 for detecting infrared are arranged in a 2-row by 2-column pixel pattern.

The pixel PX1 includes, for example, a color filter CF that selectively transmits red light and selectively absorbs green light, blue light, and infrared. The pixel PX2 includes, for example, a color filter CF that selectively transmits green light and selectively absorbs red light, blue light, and infrared. The pixel PX3 includes, for example, a color filter CF that selectively transmits blue light and selectively absorbs red light, green light, and infrared. The pixel PX4 is not provided with a color filter CF that absorbs infrared, for example. For example, the color filter array CFA in the portion corresponding to the pixel PX4 is a transparent layer, and transmits red light, green light, blue light, and infrared.

The projector PJ projects an infrared projection pattern onto the subject. Examples of applicable infrared projection patterns include known patterns used in a spot light projection method, a slit light projection method, a pattern light projection method, and the like.

The processing device PU1 includes, for example, an image data acquisition unit IDO, an infrared image extraction unit IRE, a visible light image extraction unit VLE1, a depth information extraction unit DIE1, a distance detection unit DD, a processing unit IMP, and an output unit OT.

The image data acquisition unit IDO acquires, for example, a plurality of pieces of image data captured in a plurality of viewpoints from a plurality of cameras CA. Each of the plurality of pieces of image data includes visible light image information and infrared image information. The image data acquisition unit IDO outputs the plurality of pieces of image data to the infrared image extraction unit IRE and the visible light image extraction unit VLE1.

For example, the infrared image extraction unit IRE extracts, from a plurality of pieces of image data, an infrared image for each piece of image data using infrared image information. The infrared image extraction unit IRE outputs the plurality of infrared images extracted from the plurality of image data to the depth information extraction unit DIE′.

For example, the visible light image extraction unit VLE1 extracts, from a plurality of pieces of image data, a visible light image for each piece of image data using visible light image information. The visible light image extraction unit VLE1 outputs a plurality of visible light images extracted from a plurality of pieces of image data to the depth information extraction unit DIE1 and the distance detection unit DD. The visible light image extraction unit VLE1 outputs at least one visible light image among a plurality of visible light images extracted from the plurality of pieces of image data to the processing unit IMP.

The extraction of the infrared image and the visible light image is performed using light quantity values (hereinafter, referred to as color value) of red, green, blue, and infrared of each pixel PX calculated by the demosaicing. For example, the signal processing unit SP performs demosaicing on the detection value of each pixel PX. The demosaicing is processing of complementing information on the wavelength (hereinafter, referred to as a color) of light missing for each pixel PX based on the detection values of surrounding pixels PX. For example, the infrared image extraction unit IRE extracts an infrared image using the color value of the infrared of each pixel PX. For example, the visible light image extraction unit VLE1 extracts a visible light image using the red, green, and blue color values of each pixel PX.

The demosaicing can be performed by various known methods. A simple method for this is a method of performing linear interpolation using detection values of a plurality of pixels PX in charge of the same color in the vicinity. The color information of each pixel PX may be estimated using a machine learning method. For example, the signal processing unit SP can estimate the color value of each color for each pixel PX from the detection value of each pixel PX using an analysis model that has been trained in machine learning to learn the relationship between the known luminance distribution and the detection value of each pixel PX.

The depth information extraction unit DIE1 extracts depth information from a plurality of pieces of image data captured by the plurality of cameras CA at a plurality of viewpoints. The depth information extraction unit DIE1 outputs the depth information to the processing unit IMP and the output unit OT as a depth map. The depth map is data defining the depths of a plurality of measurement points set in the captured image of the camera CA in association with coordinates of the individual measurement points.

The depth information extraction unit DIE1 has a passive stereo mode and an active stereo mode, for example. The passive stereo mode is a stereo mode of extracting depth information from a plurality of pieces of visible light image information included in a plurality of pieces of image data. The active stereo mode is a stereo mode of extracting depth information from a plurality of pieces of infrared image information included in a plurality of pieces of image data. The depth information extraction unit DIE1 switches the passive stereo mode and the active stereo mode in accordance with the situation.

There are various situations in which the stereo mode is switched. The passive stereo mode and the active stereo mode each have advantages and disadvantages. Stereo mode switching is performed to compensate for each other's disadvantages.

For example, the depth information extraction unit DIE1 switches the passive stereo mode and the active stereo mode in accordance with the situation based on the distance from the subject. For example, in a case where the distance from the subject is larger than a threshold, the depth information extraction unit DIE1 extracts the depth information in the passive stereo mode. In a case where the distance from the subject is the threshold or less, the depth information extraction unit DIE1 extracts the depth information in the active stereo mode.

In the active stereo method, the interval of the infrared projection pattern appearing in the image of the camera CA changes depending on the distance from the subject. When the distance from the subject increases, there is a possibility of occurrence of aliasing in relation to the arrangement density of the pixels PX4 that detect the infrared image information. Switching to the passive stereo mode in such a case will make it possible to accurately detect the depth information.

For example, the depth information extraction unit DIEL switches the stereo mode based on the distance between the camera CA and the subject detected by the distance detection unit DD. The distance between the camera CA and the subject is calculated as, for example, an average value of depth information (distances) of all measurement points in the captured image of the camera CA or a distance between the main subject and the camera CA. For example, the distance detection unit DD extracts depth information of some or all measurement points in the captured image by the passive stereo method using a plurality of visible light images extracted by the visible light image extraction unit VLE1. The distance detection unit DD detects the distance between the camera CA and the subject based on the extracted depth information.

Based on the depth information, the processing unit IMP processes the visible light image generated using the visible light image information included in at least one piece of image data among the plurality of pieces of image data. For example, one camera CA among the plurality of cameras CA is selected as the reference camera. Selection of the reference camera can be performed in any manner. In the present embodiment, for example, the first camera CA1 is selected as the reference camera. The processing unit IMP performs image processing (foreground/background separation, refocusing, relighting, and the like) based on the depth information on the visible light image (reference image) generated using the visible light image information included in the image data of the reference camera. The processing unit IMP outputs the visible light image (processed image) obtained by the image processing to the output unit OT.

The output unit OT outputs the visible light image output from the processing unit INP and the depth information output from the depth information extraction unit DIE1 to an external device.

The storage device ST1 stores a program PG1 executed by the processing device PU1, for example. The program PG1 is a program that causes a computer to execute information processing according to the present embodiment. The processing device PU1 performs various types of processing according to the program PG1 stored in the storage device ST1. The storage device ST1 may be used as a work area for temporarily storing a processing result of the processing device PU1. The storage device ST1 includes, for example, any non-transitory storage medium such as a semiconductor storage medium and a magnetic storage medium. The storage device ST1 includes an optical disk, a magneto-optical disk, or flash memory, for example. The program PG1 is stored in a non-transitory computer-readable storage medium, for example.

The processing device PU1 is a computer including a processor and memory, for example. The memory of the processing device PU1 includes random access memory (RAM) and read only memory (ROM). By executing the program PG1, the processing device PU1 functions as the image data acquisition unit IDO, the infrared image extraction unit IRE, the visible light image extraction unit VLE1, the depth information extraction unit DIE1, the distance detection unit DD, the processing unit IMP, and the output unit OT.

[1-2. Information Processing Method]

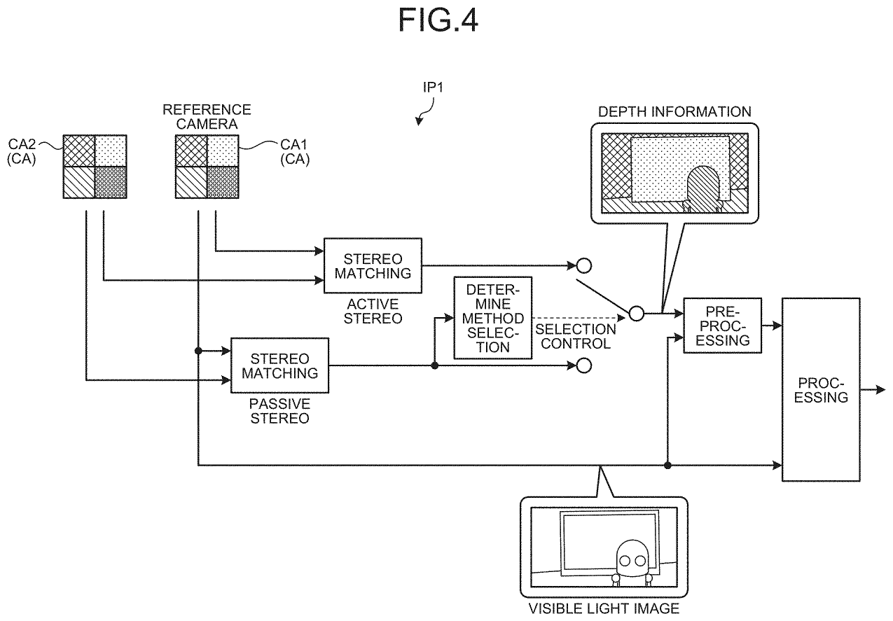

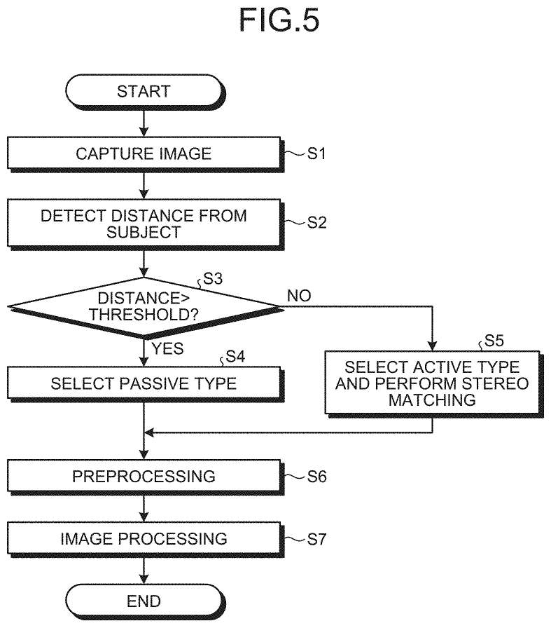

FIGS. 4 and 5 are diagrams illustrating an example of an information processing method according to the present embodiment. FIG. 4 is a conceptual diagram of information processing. FIG. 5 is a flowchart illustrating an information processing method.

In step S1, a plurality of cameras CA captures a subject from a plurality of viewpoints. For example, the first camera CA captures image data of the first viewpoint. The second camera CA2 captures image data of the second viewpoint. The image data acquisition unit IDO acquires a plurality of pieces of image data captured from a plurality of viewpoints. The visible light image extraction unit VLE1 extracts, from a plurality of pieces of image data, a visible light image for each piece of image data using visible light image information.

In step S2, the distance detection unit DD extracts depth information regarding some or all of the measurement points in the captured image of the camera CA by the passive stereo method using the plurality of visible light images extracted from the plurality of pieces of image data. The distance detection unit DD detects the distance between the camera CA and the subject using the extracted depth information.

In step S3, the depth information extraction unit DIE1 determines whether the distance detected by the distance detection unit DD is larger than a threshold. In step S3, when it is determined that the distance is larger than the threshold (step S3: Yes), the process proceeds to step S4. In step S4, the depth information extraction unit DIE1 selects the passive stereo mode. The depth information extraction unit DIE1 extracts the depth information by the passive stereo method using the plurality of visible light images extracted by the visible light image extraction unit VLE1. Subsequently, the process proceeds to step S6. When the distance detection unit DD has extracted the depth information of all the measurement points in the captured image of the camera CA in step S2, the depth information extraction unit DIE1 outputs the depth information extracted by the distance detection unit DD to the processing unit IMP and the output unit OT as it is.

In step S3, when it is determined that the distance is the threshold or less (step S3: No), the process proceeds to step S5. In step S5, the depth information extraction unit DIE1 selects the active stereo mode. The depth information extraction unit DIE1 extracts the depth information by the active stereo method using the plurality of infrared images extracted by the infrared image extraction unit IRE. Subsequently, the process proceeds to step S6.

In step S6, the processing unit IMP performs preprocessing on the visible light image acquired from the visible light image extraction unit VLE1. This visible light image is a reference image generated using visible light image information included in image data of the first camera CA1 (reference camera). The preprocessing includes, for example, missing data interpolation processing and upsampling processing. The missing data interpolation processing is processing of obtaining missing information by interpolation. The upsampling processing is processing of converting the sampling frequency to a higher frequency.

In step S7, the processing unit IMP performs image processing (foreground/background separation, refocusing, relighting, and the like) based on the depth information on the preprocessed visible light image.

[1-3. Effects]

The information processing apparatus IP1 includes the depth information extraction unit DIE1 and the processing unit IMP. The depth information extraction unit DIE1 can extract depth information from a plurality of pieces of infrared image information included in a plurality of pieces of image data. The plurality of pieces of image data is image data captured from a plurality of viewpoints. Each of the plurality of pieces of image data includes visible light image information and infrared image information. Based on the depth information, the processing unit IMP processes the visible light image generated using the visible light image information included in at least one piece of image data among the plurality of pieces of image data. With the information processing method of the present embodiment, the information processing of the information processing apparatus described above is executed by a computer. The program of the present embodiment causes the computer to implement information processing of the information processing apparatus described above.

According to this configuration, the infrared image information for detecting the depth information and the visible light image information for generating the viewing image are included in the image data of the same viewpoint. Therefore, a position shift is less likely to occur between the depth map generated using the depth information and the visible light image. This facilitate execution of image processing using the depth information.

The depth information extraction unit DIEL switches the passive stereo mode and the active stereo mode in accordance with the situation. The passive stereo mode is a stereo mode of extracting depth information from a plurality of pieces of visible light image information included in a plurality of pieces of image data. The active stereo mode is a stereo mode of extracting depth information from a plurality of pieces of infrared image information included in a plurality of pieces of image data.

The passive stereo mode and the active stereo mode each have advantages and disadvantages. Switching the stereo mode in accordance with the situation can compensate for each other's disadvantage.

The depth information extraction unit DIE1 switches the passive stereo mode and the active stereo mode in accordance with the situation based on the distance from the subject.

In the active stereo method, the interval of the infrared projection pattern appearing in the image of the camera CA changes depending on the distance from the subject. When the distance from the subject increases, there is a possibility of occurrence of aliasing in relation to the arrangement density of the pixels PX4 that detect the infrared image information. Switching to the passive stereo mode in such a case will make it possible to accurately detect the depth information.

The information processing apparatus IP1 includes the plurality of image sensors IS that capture a plurality of pieces of image data. Each of the plurality of image sensors IS has a structure in which the plurality of pixels PX (pixels PX1, PX2, and PX3) for detecting visible light image information and the plurality of pixels PX (pixels PX4) for detecting infrared image information are periodically arranged in a two-dimensional direction.

With this configuration, the infrared image information and the visible light image information are easily extracted separately from each other.

Each of the plurality of image sensors IS includes the plurality of pixel blocks PB arranged two-dimensionally. Each of the plurality of pixel blocks PB has a structure in which one pixel PX1 for detecting red light, one pixel PX2 for detecting green light, one pixel PX3 for detecting blue light, and one pixel PX4 for detecting infrared are arranged in a 2-row by 2-column pixel pattern.

According to this configuration, information of red, green, blue, and infrared can be detected in a well-balanced manner.

### 2. Second Embodiment

[2-1. Configuration of Information Processing Apparatus]

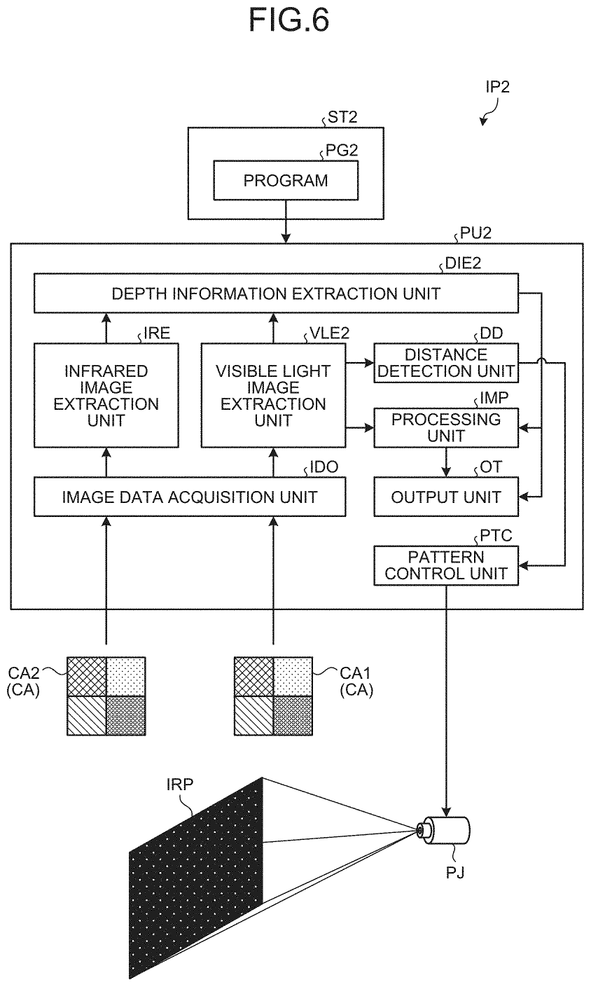

FIG. 6 is a schematic diagram of an information processing apparatus IP2 according to the second embodiment.

The present embodiment is different from the first embodiment in that the depth information is extracted by the active stereo method, and a processing device PU2 includes a pattern control unit PTC. Hereinafter, differences from the first embodiment will be mainly described.

The depth information is not extracted by the passive stereo method. Therefore, a visible light image extraction unit VLE2 does not output the plurality of visible light images extracted from the plurality of pieces of image data to a depth information extraction unit DIE2. The distance detection unit DD outputs information regarding the distance between the camera CA and the subject (distance from the subject) to the pattern control unit PTC. The pattern control unit PTC changes an infrared projection pattern IRP used in the active stereo mode in accordance with the distance from the subject.

For example, in a case where the distance from the subject is larger than a threshold, the pattern control unit PTC projects a coarse long-distance pattern having a large interval between spots or slits as the infrared projection pattern IRP. In a case where the distance from the subject is the threshold or less, the pattern control unit PTC projects a fine short-range pattern having a narrow interval between spots or slits as the infrared projection pattern IRP.

The storage device ST2 stores a program PG2 executed by the processing device PU2, for example. The program PG2 is a program that causes a computer to execute information processing according to the present embodiment. The processing device PU2 performs various types of processing in accordance with the program PG2 stored in the storage device ST2. By executing the program PG2, the processing device PU2 functions as the image data acquisition unit IDO, the infrared image extraction unit IRE, the visible light image extraction unit VLE2, the depth information extraction unit DIE2, the distance detection unit DD, the processing unit IMP, the output unit OT, and the pattern control unit PTC.

[2-2. Information Processing Method]

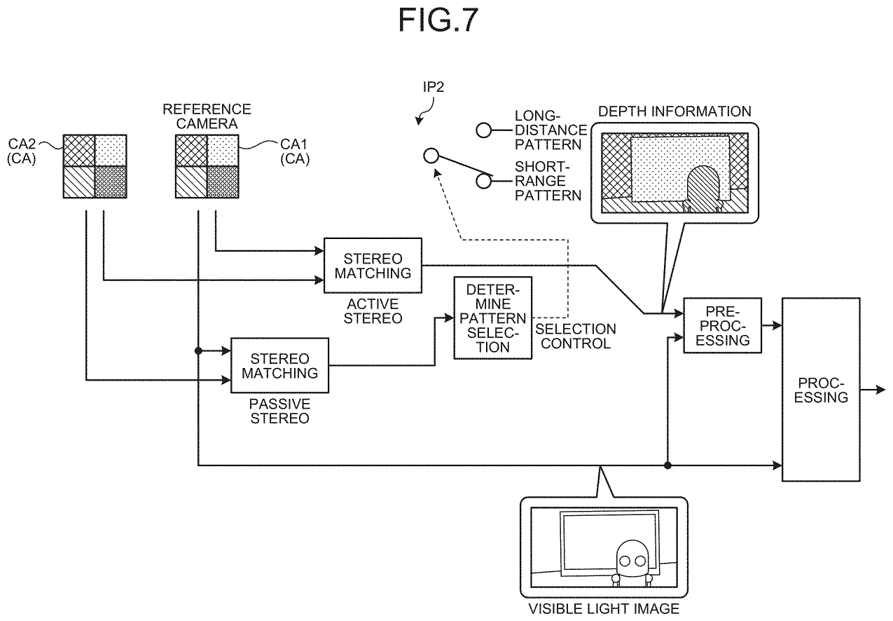

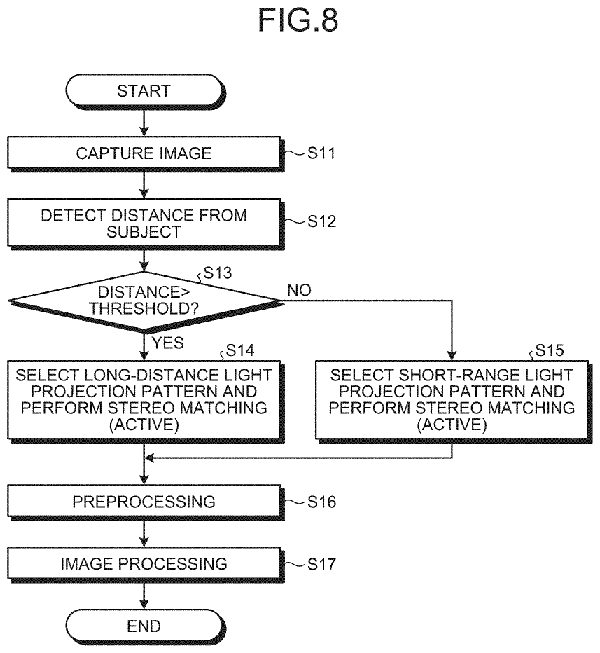

FIGS. 7 and 8 are diagrams illustrating an example of an information processing method according to the present embodiment. FIG. 7 is a conceptual diagram of information processing. FIG. 8 is a flowchart illustrating an information processing method.

In step S11, the plurality of cameras CA captures the subject from a plurality of viewpoints. The image data acquisition unit IDO acquires a plurality of pieces of image data captured from a plurality of viewpoints. The visible light image extraction unit VLE1 extracts, from a plurality of pieces of image data, a visible light image for each piece of image data using visible light image information.

In step S12, by the passive stereo method using the plurality of visible light images extracted from the plurality of pieces of image data, the distance detection unit DD extracts depth information of some or all of the measurement points in an image capturing region. The distance detection unit DD detects the distance between the camera CA and the subject using the extracted depth information.

In step S13, the pattern control unit PTC determines whether the distance detected by the distance detection unit DD is larger than a threshold. In a case where it is determined in step S13 that the distance is larger than the threshold (step S13: Yes), the process proceeds to step S14. In step S14, the pattern control unit PTC projects a long-distance pattern as the infrared projection pattern IRP. The depth information extraction unit DIE2 extracts the depth information by an active stereo method using a plurality of infrared images in which a long-distance pattern appears. Subsequently, the process proceeds to step S16.

In a case where it is determined in step S13 that the distance is the threshold or less (step S13: No), the process proceeds to step S15. In step S15, the pattern control unit PTC projects a short-range pattern as the infrared projection pattern IRP. The depth information extraction unit DIE2 extracts the depth information by an active stereo method using a plurality of infrared images in which a short-range pattern appears. Subsequently, the process proceeds to step S16.

In step S16, the processing unit IMP performs preprocessing on the visible light image acquired from the visible light image extraction unit VLE2. This visible light image is a reference image generated using visible light image information included in image data of the first camera CA1 (reference camera).

In step S17, the processing unit IMP performs image processing based on the depth information on the preprocessed visible light image.

[2-3. Effects]

The information processing apparatus IP2 includes a pattern control unit PTC. The pattern control unit PTC changes an infrared projection pattern used in the active stereo mode in accordance with the distance from the subject. With this configuration, it is possible to suppress occurrence of aliasing.

### 3. Third Embodiment

[3-1. Configuration of Information Processing Apparatus]

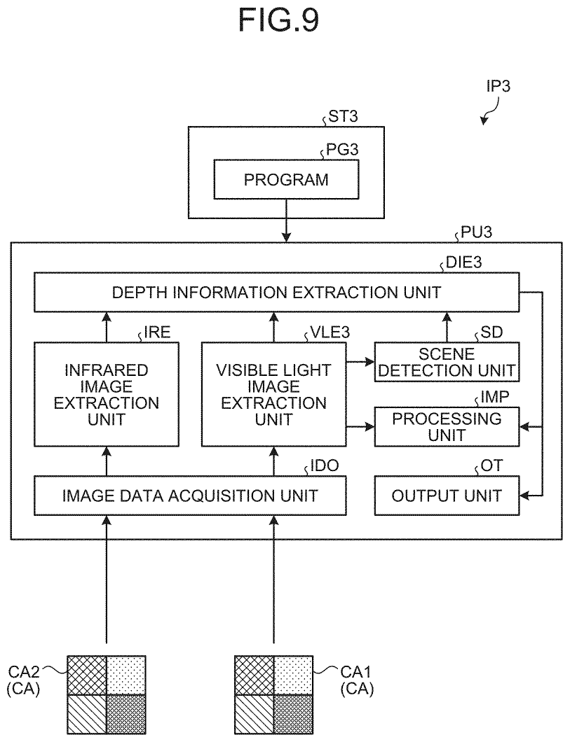

FIG. 9 is a schematic diagram of an information processing apparatus IP3 according to a third embodiment.

The present embodiment is different from the first embodiment in that a depth information extraction unit DIE3 switches between the passive stereo mode and the active stereo mode in accordance with the situation based on an image capturing scene. Hereinafter, differences from the first embodiment will be mainly described.

A processing device PU3 includes a scene detection unit SD, for example. For example, a visible light image extraction unit VLE3 outputs one of a plurality of visible light images extracted from a plurality of pieces of image data to the scene detection unit SD. The scene detection unit SD detects the image capturing scene based on the visible light image output from the visible light image extraction unit VLE3, for example. The image capturing scenes to be detected include, for example, “daytime & outdoor”, “indoor”, and “dark”. “Daytime & outdoor” indicates an image capturing scene of outdoors during the day. “Indoor” indicates an image capturing scene indoors. “Dark” indicates an image capturing scene in a dark environment.

It is possible to flexibly select the image data from which the visible light image has been extracted in the detection of the image capturing scene. In the present embodiment, for example, the image capturing scene is detected based on a visible light image (reference image) extracted from image data captured by the reference camera (first camera CA1).

In detection of the image capturing scene, a known scene recognition technique using artificial intelligence (AI) adopted in a digital camera, a smartphone, and the like is used. As described in JP 2011-250281 A, it is also possible to determine whether the environment is an indoor environment or an outdoor environment by estimating the number of GPS satellites captured. As described in JP 2013-526215 A, it is also possible to determine whether the environment is an indoor environment or an outdoor environment from the strength of the GPS signal. In a case where the information processing apparatus IP3 includes an illuminance sensor, the image capturing scene may be determined by combining the information of the illuminance sensor with the above-described method.

For example, the depth information extraction unit DIE3 switches the stereo mode based on the image capturing scene detected by the scene detection unit SD. For example, when “daytime & outdoor” is detected as the image capturing scene, the depth information extraction unit DIE3 extracts the depth information in the passive stereo mode. In a case where “indoor” or “dark” is detected as the image capturing scene, the depth information extraction unit DIE3 extracts the depth information in the active stereo mode.

A storage device ST3 stores a program PG3 executed by the processing device PU3, for example. The program PG3 is a program that causes a computer to execute information processing according to the present embodiment. The processing device PU3 performs various types of processing in accordance with the program PG3 stored in the storage device ST3. By executing the program PG3, the processing device PU3 functions as the image data acquisition unit IDO, the infrared image extraction unit IRE, the visible light image extraction unit VLE3, the depth information extraction unit DIE3, the scene detection unit SD, the processing unit IMP, and the output unit OT.

[3-2. Information Processing Method]

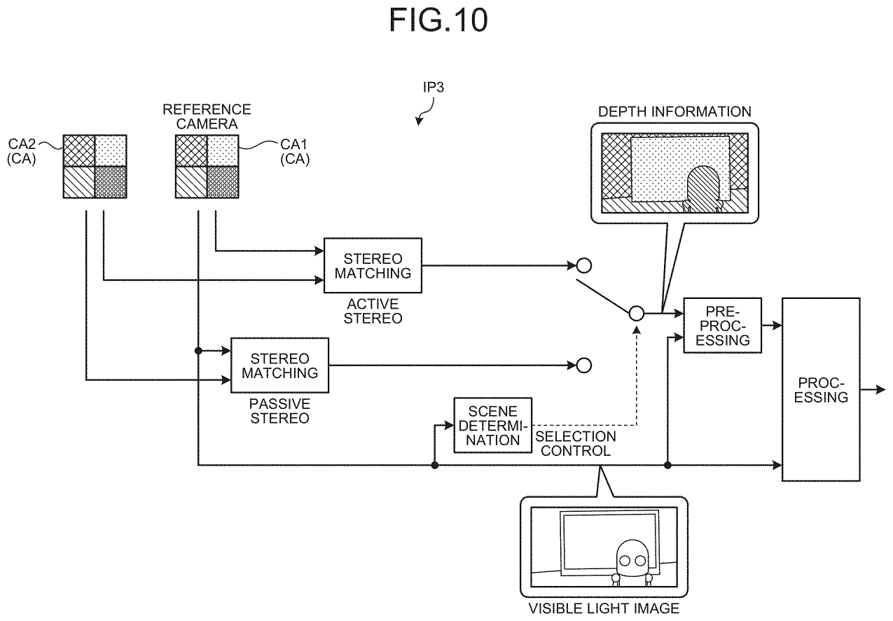

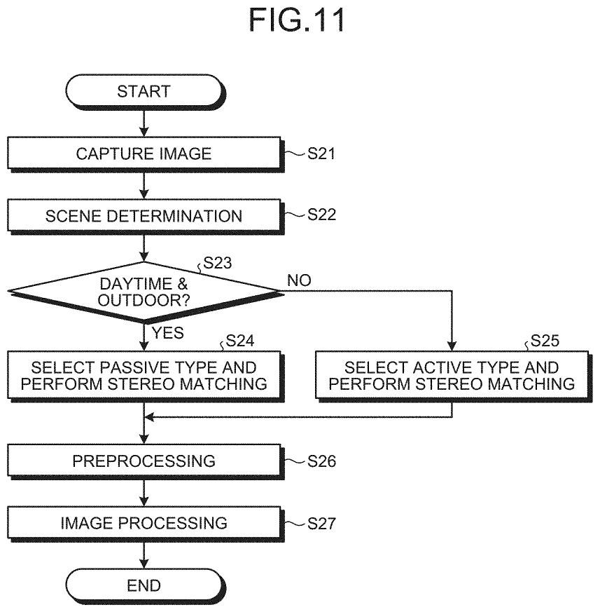

FIGS. 10 and 11 are diagrams illustrating an example of an information processing method of the present embodiment. FIG. 10 is a conceptual diagram of information processing. FIG. 11 is a flowchart illustrating an information processing method.

In step S21, the plurality of cameras CA captures the subject from a plurality of viewpoints. The image data acquisition unit IDO acquires a plurality of pieces of image data captured from a plurality of viewpoints. The visible light image extraction unit VLE3 extracts, from a plurality of pieces of image data, a visible light image for each piece of image data using visible light image information.

In step S22, the scene detection unit SD detects the image capturing scene based on one of the plurality of visible light images extracted by the visible light image extraction unit VLE3.

In step S23, the depth information extraction unit DIE 3 determines whether “daytime & outdoor” has been detected as the image capturing scene. In step S23, when it is determined that “daytime & outdoor” has been detected (step S23: Yes), the process proceeds to step S24. In step S24, the depth information extraction unit DIE 3 selects the passive stereo mode. The depth information extraction unit DIE3 extracts the depth information by the passive stereo method using the plurality of visible light images extracted by the visible light image extraction unit VLE3. Subsequently, the process proceeds to step S26.

In step S23, when it is determined that “daytime & outdoor” is not detected (step S23: No), the process proceeds to step S25. In step S25, the depth information extraction unit DIE3 selects the active stereo mode. The depth information extraction unit DIE3 extracts the depth information by the active stereo method using the plurality of infrared images extracted by the infrared image extraction unit IRE. Subsequently, the process proceeds to step S26.

In step S26, the processing unit IMP performs preprocessing on the visible light image acquired from the visible light image extraction unit VLE3. This visible light image is a reference image generated using visible light image information included in image data of the first camera CA1 (reference camera).

In step S27, the processing unit IMP performs image processing based on the depth information on the preprocessed visible light image.

[3-3. Effects]

For example, the depth information extraction unit DIE3 switches the passive stereo mode and the active stereo mode in accordance with the situation based on the image capturing scene.

In the stereo imaging, the detection accuracy of depth information varies depending on an image capturing scene. For example, in the active stereo method, an infrared component derived from ambient light is detected as noise. Therefore, it is difficult to accurately detect the depth information in the case of capturing images in strong sunlight. In the passive stereo method, the subject cannot be sufficiently detected in a dark environment. By switching the stereo mode to match the image capturing scene, the depth information can be detected with high accuracy.

### 4. Fourth Embodiment

[4-1. Configuration of Information Processing Apparatus]

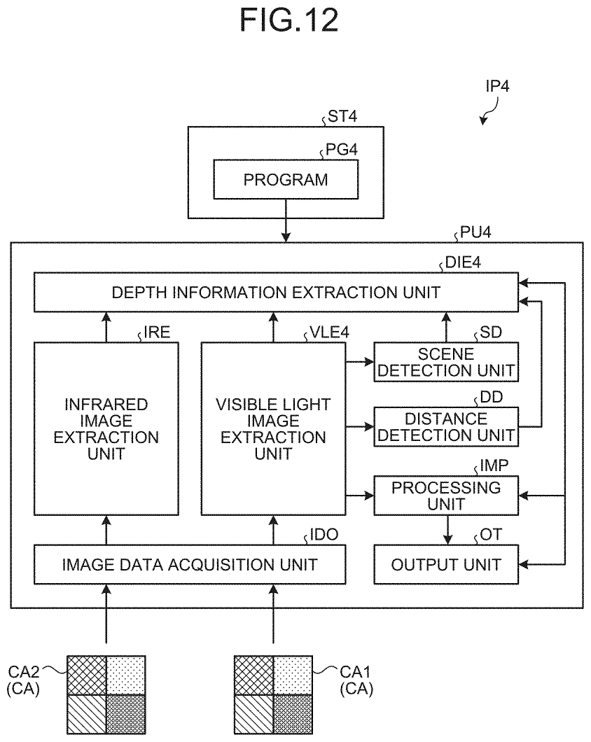

FIG. 12 is a schematic diagram of an information processing apparatus IP4 according to a fourth embodiment.

The present embodiment is different from the first embodiment and the third embodiment in that a depth information extraction unit DIE4 switches the passive stereo mode and the active stereo mode in accordance with the situation based on both the distance from the subject and the image capturing scene. Hereinafter, the difference from the first embodiment and the third embodiment will be mainly described.

A processing device PU4 includes both the distance detection unit DD and the scene detection unit SD, for example. For example, the depth information extraction unit DIE4 switches the stereo mode based on both the distance from the subject detected by the distance detection unit DD and the image capturing scene detected by the scene detection unit SD. For example, when “daytime & outdoor” is detected as the image capturing scene, the depth information extraction unit DIE4 selects the outdoor control mode. In a case where “indoor” or “dark” is detected as the image capturing scene, the depth information extraction unit DIE4 selects the indoor control mode.

The outdoor control mode is a type of control of proactively selecting the passive stereo mode. The indoor control mode is a type of control of proactively control the active stereo mode. The outdoor control mode and the indoor control mode have different distance conditions (thresholds) for switching the stereo mode.

For example, in a case where the outdoor control mode is selected, the following control is performed. First, when the distance from the subject is larger than a first threshold, the depth information extraction unit DIE4 extracts the depth information in the passive stereo mode. In a case where the distance from the subject is the first threshold or less, the depth information extraction unit DIE4 extracts the depth information in the active stereo mode.

When the indoor control mode is selected, the following control is performed. First, when the distance from the subject is larger than a second threshold, the depth information extraction unit DIE4 extracts the depth information in the passive stereo mode. In a case where the distance from the subject is the second threshold or less, the depth information extraction unit DIE4 extracts the depth information in the active stereo mode.

The first threshold is smaller than the second threshold. Therefore, when the distance from the subject is the same, the distance range in which the passive stereo mode is selected is wider in the case where the outdoor control mode is selected than in the case where the indoor control mode is selected. Therefore, when the outdoor control mode is selected, the passive stereo mode is proactively selected. Conversely, when the distance from the subject is the same, the distance range in which the active stereo mode is selected is wider in the case where the indoor control mode is selected than in the case where the outdoor control mode is selected. Therefore, when the indoor control mode is selected, the active stereo mode is proactively selected.

In the active stereo method, an infrared component derived from ambient light is detected as noise. In the outdoors in the day time, the detection value derived from the infrared projection pattern is easily buried in the surrounding noise due to the influence of the infrared included in the ambient light (sunlight). Therefore, it is difficult to accurately detect the depth information in the case of capturing images in strong sunlight. The longer the distance from the subject, the more significant the decrease in detection accuracy. Therefore, by proactively selecting the passive stereo mode in such a case, the depth information can be detected with high accuracy.

On the contrary, the influence of infrared included in ambient light is smaller indoors than outdoors in the day time. Therefore, the detection value derived from the infrared projection pattern is not likely to be buried in the surrounding noise. Therefore, by proactively selecting the active stereo mode in such a case, the depth information can be detected with high accuracy.

A storage device ST4 stores a program PG4 executed by the processing device PU4, for example. The program PG4 is a program that causes a computer to execute information processing according to the present embodiment. The processing device PU4 performs various types of processing according to the program PG4 stored in the storage device ST4. By executing the program PG4, the processing device PU4 functions as the image data acquisition unit IDO, the infrared image extraction unit IRE, a visible light image extraction unit VLE4, the depth information extraction unit DIE4, the distance detection unit DD, the scene detection unit SD, the processing unit IMP, and the output unit OT.

[4-2. Information Processing Method]

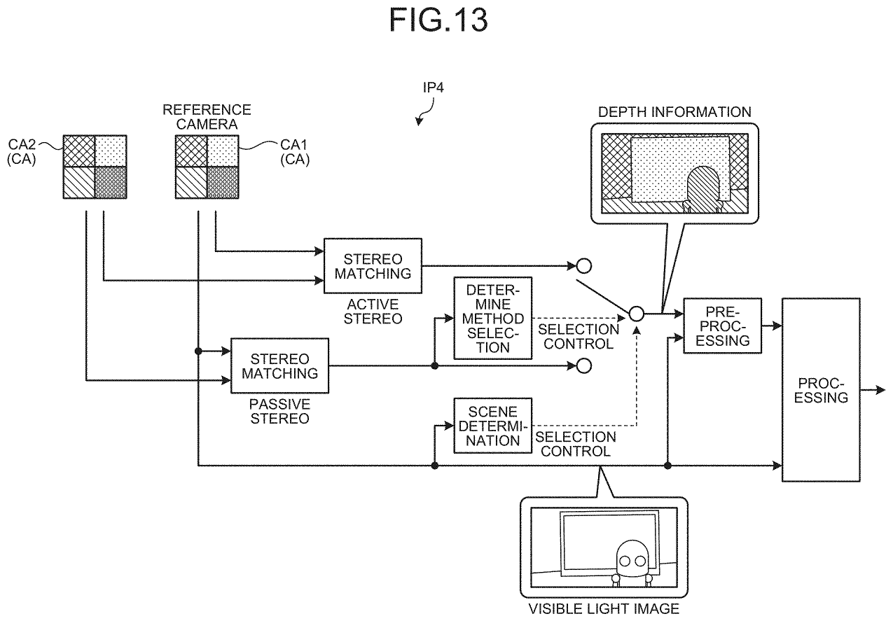

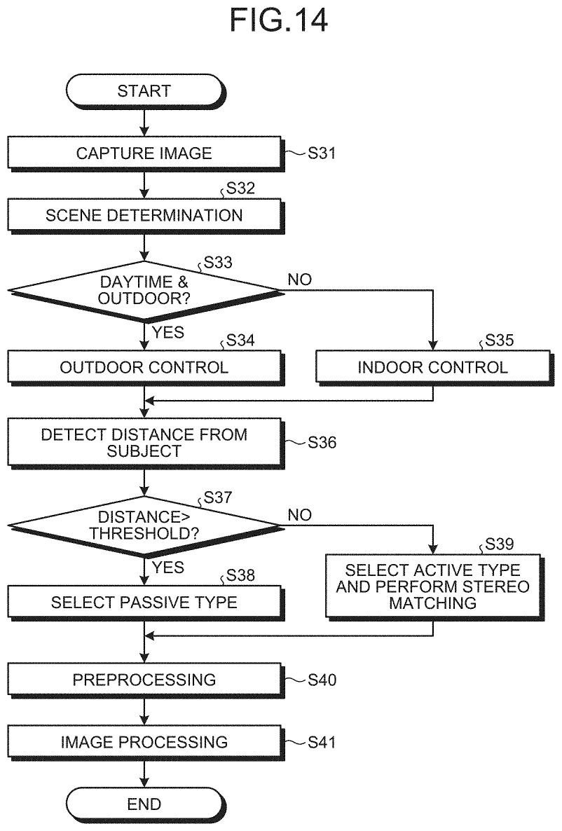

FIGS. 13 and 14 are diagrams illustrating an example of an information processing method of the present embodiment. FIG. 13 is a conceptual diagram of information processing. FIG. 14 is a flowchart illustrating an information processing method.

In step S31, the plurality of cameras CA captures the subject from a plurality of viewpoints. The image data acquisition unit IDO acquires a plurality of pieces of image data captured from a plurality of viewpoints. The visible light image extraction unit VLE4 extracts, from a plurality of pieces of image data, a visible light image for each piece of image data using visible light image information.

In step S32, the scene detection unit SD detects the image capturing scene based on one of the plurality of visible light images extracted by the visible light image extraction unit VLE4.

In step S33, the depth information extraction unit DIE4 determines whether “daytime & outdoor” is detected as the image capturing scene. In step S33, when it is determined that “daytime & outdoor” is detected (step S33: Yes), the process proceeds to step S34. In step S34, the depth information extraction unit DIE3 selects the outdoor control mode. Subsequently, the process proceeds to step S36.

In step S33, when it is determined that “daytime & outdoor” is not detected (step S33: No), the process proceeds to step S35. In step S35, the depth information extraction unit DIE4 selects the indoor control mode. Subsequently, the process proceeds to step S36.

In step S36, the distance detection unit DD extracts depth information regarding some or all of the measurement points in the captured image of the camera CA by the passive stereo method using the plurality of visible light images extracted from the plurality of pieces of image data. The distance detection unit DD detects the distance between the camera CA and the subject using the extracted depth information.

In step S37, the depth information extraction unit DIE4 determines whether the distance detected by the distance detection unit DD is larger than a threshold. The threshold serving as a criterion for determination in step S37 is different between a case where the outdoor control mode is selected and a case where the indoor control mode is selected. The threshold when the outdoor control mode is selected is the first threshold. The threshold when the indoor control mode is selected is the second threshold. The first threshold is smaller than the second threshold.

When it is determined in step S37 that the distance is larger than the threshold (step S37: Yes), the process proceeds to step S38. In step S38, the depth information extraction unit DIE 4 selects the passive stereo mode. The depth information extraction unit DIE4 extracts the depth information by a passive stereo method using the plurality of visible light images extracted by the visible light image extraction unit VLE4. Subsequently, the process proceeds to step S40. When the distance detection unit DD has extracted the depth information of all the measurement points in the captured image of the camera CA in step S36, the depth information extraction unit DIE4 outputs the depth information extracted by the distance detection unit DD to the processing unit IMP and the output unit OT as it is.

When it is determined in step S37 that the distance is the threshold or less (step S37: No), the process proceeds to step S39. In step S39, the depth information extraction unit DIE4 selects the active stereo mode. The depth information extraction unit DIE4 extracts the depth information by an active stereo method using the plurality of infrared images extracted by the infrared image extraction unit IRE. Subsequently, the process proceeds to step S40.

In step S40, the processing unit IMP performs preprocessing on the visible light image acquired from the visible light image extraction unit VLE4. This visible light image is a reference image generated using visible light image information included in image data of the first camera CA1 (reference camera).

In step S41, the processing unit IMP performs image processing based on the depth information on the preprocessed visible light image.

[4-3. Effects]

The depth information extraction unit DIE4 switches the passive stereo mode and the active stereo mode in accordance with a situation based on both the distance from the subject and the image capturing scene. Therefore, the depth information is accurately detected in various situations.

### 5. Fifth Embodiment

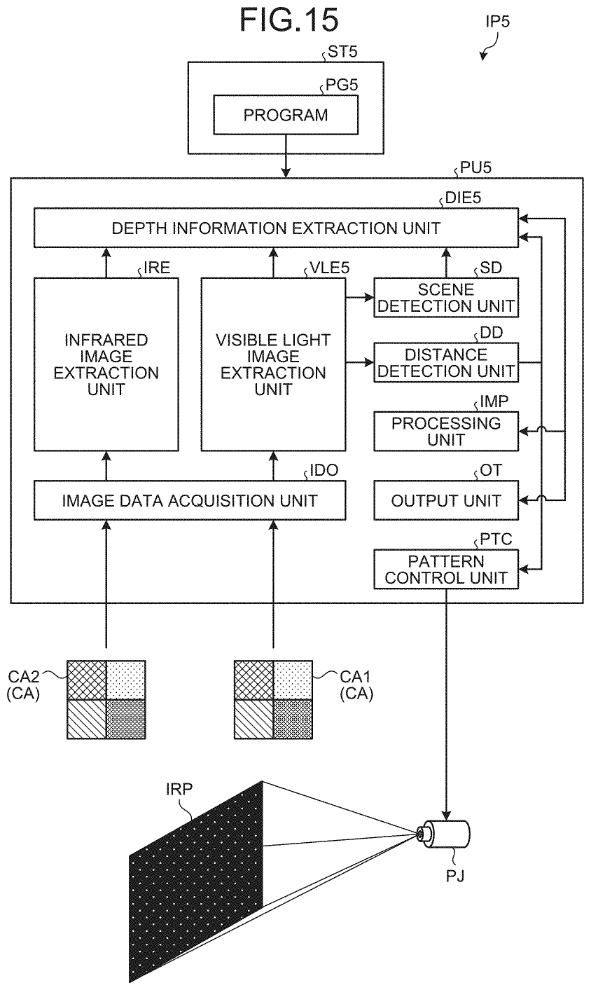

FIG. 15 is a schematic diagram of an information processing apparatus IP5 according to the fifth embodiment.

The present embodiment is different from the fourth embodiment in that information regarding the distance from the subject detected by the distance detection unit DD is used for the control of the infrared projection pattern by the pattern control unit PTC described in the second embodiment. Hereinafter, the difference from the second embodiment and the fourth embodiment will be mainly described.

The processing device PU2 includes a pattern control unit PTC. The function of the pattern control unit PTC is similar to that described in the second embodiment. The pattern control unit PTC changes an infrared projection pattern IRP used in the active stereo mode in accordance with the distance from the subject.

The distance detection unit DD detects the distance from the subject based on the plurality of visible light images extracted by a visible light image extraction unit VLE5. When the distance from the subject is larger than a threshold, the pattern control unit PTC projects a long-distance pattern as the infrared projection pattern IRP. A depth information extraction unit DIE5 extracts depth information by the active stereo method using a plurality of infrared images in which the long-distance pattern appears. When the distance from the subject is the threshold or less, the pattern control unit PTC projects the short-range pattern as the infrared projection pattern IRP. The depth information extraction unit DIE5 extracts the depth information by an active stereo method using a plurality of infrared images in which a short-range pattern appears.

A distance condition (threshold) for switching the infrared projection pattern IRP is different between the outdoor control mode and the indoor control mode.

For example, in a case where the outdoor control mode is selected, the following control is performed. First, when the distance from the subject is larger than the first threshold, the pattern control unit PTC projects a long-distance pattern as the infrared projection pattern IRP. When the distance from the subject is the first threshold or less, the pattern control unit PTC projects a short-range pattern as the infrared projection pattern IRP.

For example, in a case where the indoor control mode is selected, the following control is performed. First, when the distance from the subject is larger than the second threshold, the pattern control unit PTC projects a long-distance pattern as the infrared projection pattern IRP. When the distance from the subject is the second threshold or less, the pattern control unit PTC projects a short-range pattern as the infrared projection pattern IRP.

A storage device ST5 stores a program PG5 executed by a processing device PU5, for example. The program PG5 is a program that causes a computer to execute information processing according to the present embodiment. The processing device PU5 performs various types of processing according to the program PG5 stored in the storage device ST5. By executing the program PG5, the processing device PU5 functions as the image data acquisition unit IDO, the infrared image extraction unit IRE, the visible light image extraction unit VLE5, the depth information extraction unit DIE5, the distance detection unit DD, the scene detection unit SD, the processing unit IMP, the output unit OT, and the pattern control unit PTC.

In the present embodiment, in addition to the effect of the fourth embodiment, it is possible to obtain an effect of suppressing the occurrence of aliasing when the distance from the subject increases.

### 6. Variations of Pixel Array Unit

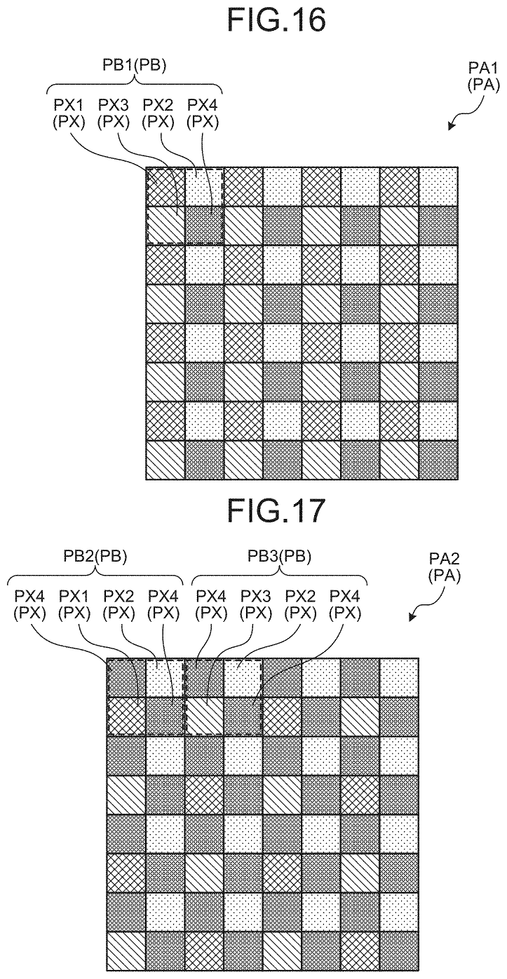

FIGS. 16 to 21 are diagrams illustrating variations of the pixel array unit PA.

FIG. 16 is a diagram illustrating a pixel array unit PA1 according to a first variation. The pixel array unit PA1 is the same as that described in the first to fifth embodiments. The image sensor IS includes a plurality of pixel blocks PB1 arranged two-dimensionally. Each of the plurality of pixel blocks PB1 has a structure in which one pixel PX1 for detecting red light, one pixel PX2 for detecting green light, one pixel PX3 for detecting blue light, and one pixel PX4 for detecting infrared are arranged in a 2-row by 2-column pixel pattern.

According to this configuration, information of red, green, blue, and infrared can be detected in a well-balanced manner.

FIG. 17 is a diagram illustrating a pixel array unit PA2 according to a second variation. The image sensor IS has a structure in which a plurality of pixel blocks (first pixel blocks) PB2 and a plurality of pixel blocks (second pixel blocks) PB3 are periodically arranged in a two-dimensional direction. Each of the plurality of pixel blocks PB2 has a structure in which one pixel PX1 for detecting red light, one pixel PX2 for detecting green light, and two pixels PX4 for detecting infrared are arranged in a 2-row by 2-column pixel pattern. Each of the plurality of pixel blocks PB3 has a structure in which one pixel PX2 for detecting green light, one pixel PX3 for detecting blue light, and two pixels PX4 for detecting infrared are arranged in a 2-row by 2-column pixel pattern.

According to this configuration, the pixels PX4 for detecting infrared are arranged at high density. This increases the resolution of the infrared. This also increases the sensitivity of infrared, leading to an increases distance (threshold) to the subject that allows extraction of depth information in the active stereo mode. In addition, the pixel PX1 for detecting red light, the pixel PX2 for detecting green light, and the pixel PX3 for detecting blue light are uniformly arranged at the same period. Therefore, information of red, blue, and green is detected in a well-balanced manner.

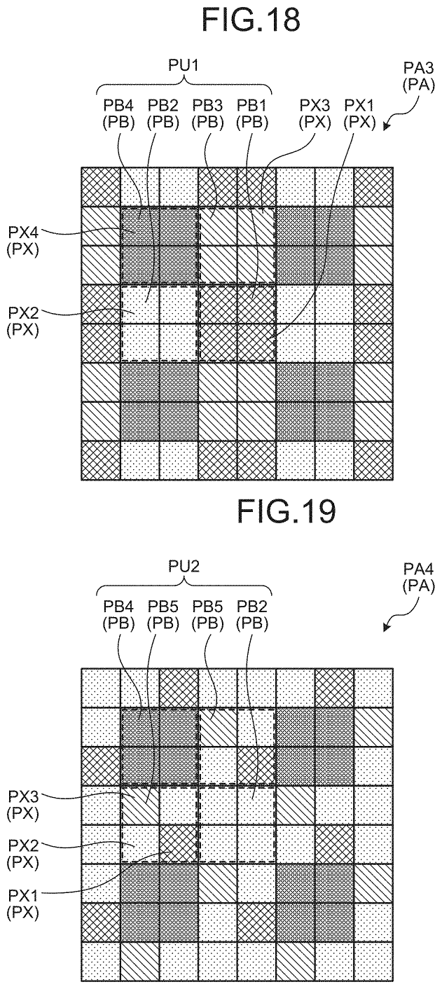

FIG. 18 is a diagram illustrating a pixel array unit PA3 according to a third variation. The image sensor IS includes a plurality of pixel units PU1 arranged two-dimensionally. Each of the plurality of pixel units PU1 includes a plurality of pixel blocks PB to which different colors are allocated. Each of the plurality of pixel blocks PB includes a plurality of pixels PX arranged adjacent to each other. The plurality of pixels PX constituting the pixel block PB detect light of a color allocated to the pixel block PB.

For example, the pixel unit PU1 has a structure in which a pixel block PB1, a pixel block PB2, a pixel block PB3, and a pixel block PB4 are arranged in a 2-row by 2-column pixel pattern. The pixel block PB1 is a pixel block PB to which red is allocated. In the pixel block PB1, four pixels PX1 for detecting red light are arranged in a 2-row by 2-column pixel pattern. The pixel block PB2 is a pixel block PB to which green is allocated. In the pixel block PB2, four pixels PX2 for detecting green light are arranged in a 2-row by 2-column pixel pattern. The pixel block PB3 is a pixel block PB to which blue is allocated. In the pixel block PB3, four pixels PX3 for detecting blue light are arranged in a 2-row by 2-column pixel pattern. The pixel block PB4 is a pixel block PB to which infrared is allocated. In the pixel block PB4, four pixels PX4 for detecting infrared are arranged in a 2-row by 2-column pixel pattern.

According to this configuration, the image sensor IS has a structure in which a plurality of pixel blocks PB1 to which red is allocated, a plurality of pixel blocks PB2 to which green is allocated, a plurality of pixel blocks PB3 to which blue is allocated, and a plurality of pixel blocks PB4 to which infrared are allocated are periodically arranged in a two-dimensional direction. Therefore, by performing binning for each pixel block, it is possible to detect red, green, blue, and infrared information with high sensitivity. This also increases the sensitivity of infrared, leading to an increases distance (threshold) to the subject that allows extraction of depth information in the active stereo mode. In addition, the pixel PX1 for detecting red light, the pixel PX2 for detecting green light, and the pixel PX3 for detecting blue light are uniformly arranged at the same period. Therefore, information of red, blue, and green is detected in a well-balanced manner.

FIG. 19 is a diagram illustrating a pixel array unit PA4 according to a fourth variation. The image sensor IS includes a plurality of pixel units PU2 arranged two-dimensionally. The pixel unit PU2 has a structure in which one pixel block PB2, one pixel block PB4, and two pixel blocks PB5 are arranged in a 2-row by 2-column pixel pattern. The pixel block PB5 has a structure in which one pixel PX1, one pixel PX2, and two pixels PX3 are arranged in a 2-row by 2-column pixel pattern. The pixel block PB2 and the pixel block PB4 are arranged so as not to be adjacent to each other in either the row direction or the column direction.

In this configuration, the number of pixels PX2 that detect green light is the largest. Green is the color to which human eyes have the highest visual sensitivity. By increasing the number of pixels PX2, the apparent resolution is increased.

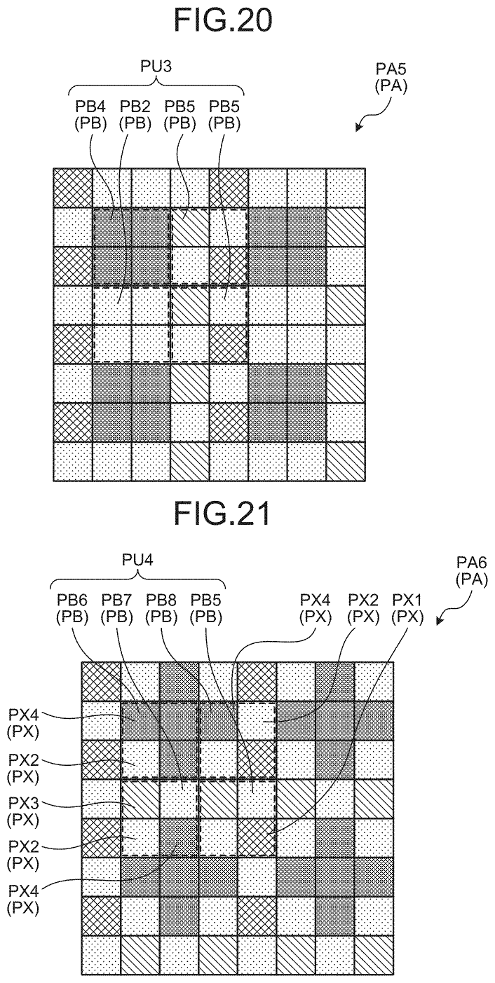

FIG. 20 is a diagram illustrating a pixel array unit PA5 according to a fifth variation. The image sensor IS includes a plurality of pixel units PU3 arranged two-dimensionally. The pixel unit PU3 has a structure in which one pixel block PB2, one pixel block PB4, and two pixel blocks PB5 are arranged in a 2-row by 2-column pixel pattern. The pixel block PB2 and the pixel block PB4 are arranged adjacent to each other in the column direction.

With this configuration, since the number of pixels PX2 is the largest, the apparent resolution is also increased.

FIG. 21 is a diagram illustrating a pixel array unit PA6 according to a sixth variation. The image sensor IS includes a plurality of pixel units PU4 arranged two-dimensionally. The pixel unit PU4 has a structure in which one pixel block PB5, one pixel block PB6, one pixel block PB7, and one pixel block PB8 are arranged in a 2-row by 2-column pixel pattern.

The pixel block PB6 has a structure in which one pixel PX2 and three pixels PX4 are arranged in a 2-row by 2-column pixel pattern. The pixel block PB7 has a structure in which two pixels PX2, one pixel PX3, and one pixel PX4 are arranged in a 2-row by 2-column pixel pattern. The pixel block PB8 has a structure in which one pixel PX1, two pixels PX2, and one pixel PX4 are arranged in a 2-row by 2-column pixel pattern.

In this configuration, the number of pixels PX2 for detecting green light and the number of pixels PX4 for detecting infrared are the largest. Therefore, infrared sensitivity is high, and apparent resolution with respect to a visible light image is also high. There is a region in which five pixels PX4 are arranged in a cross shape. Therefore, the sensitivity of the infrared is further enhanced by binning the five pixels PX.

### 7. Sixth Embodiment

[7-1. Configuration of Information Processing Apparatus]

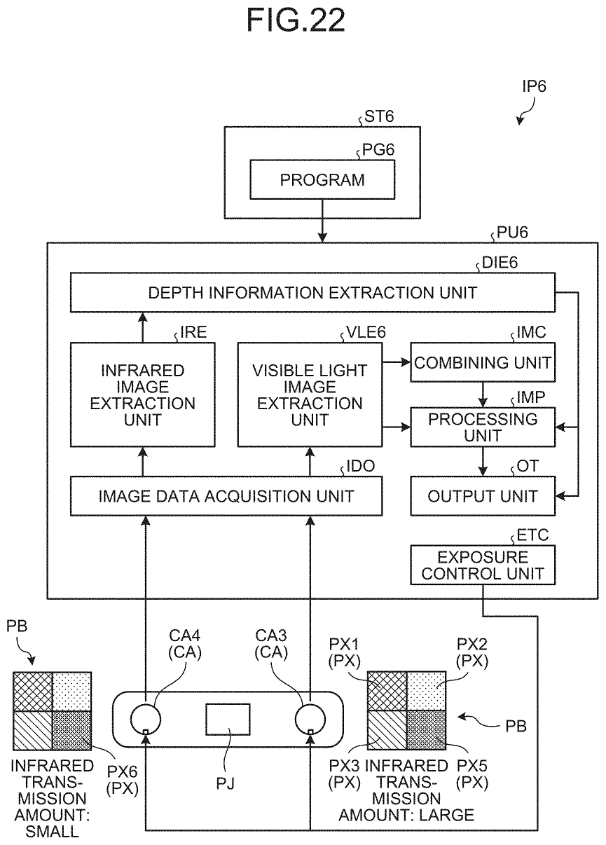

FIG. 22 is a schematic diagram of an information processing apparatus IP6 according to the sixth embodiment.

The present embodiment is different from the first embodiment in that the infrared sensitivity of the plurality of cameras CA is mutually different, the exposure period of the plurality of cameras CA is different according to the infrared sensitivity, and a processing device PU6 includes a combining unit IMC that combines a plurality of visible light images having different exposure periods. Hereinafter, differences from the first embodiment will be mainly described.

In the first to fifth embodiments, the plurality of image sensors IS included in the plurality of cameras CA all has the same structure. In the present embodiment, the infrared sensitivity of the plurality of image sensors IS is different from each other. For example, an infrared cut filter is provided in pixels PX (PX5 and PX6) for infrared image information detection in one or more cameras CA. The infrared cut filter absorbs a part of infrared incident on the pixel PX for detecting infrared image information.

The processing device PU6 includes an exposure control unit ETC, for example. For example, the exposure control unit ETC controls to vary the exposure periods of the plurality of image sensors IS in accordance with the sensitivity of the infrared of the plurality of image sensors IS, for example. The lower the sensitivity of the image sensor IS to infrared, the longer the exposure period set by the exposure control unit ETC. With this setting, the exposure control unit ETC equalizes the levels of brightness of the infrared images detected by the plurality of image sensors.

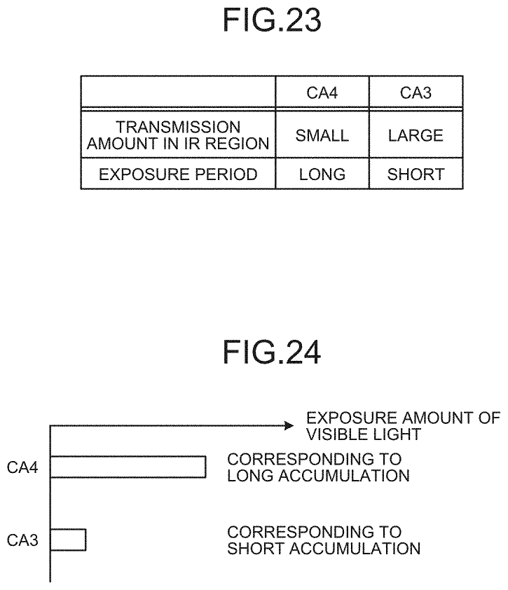

FIG. 23 is a diagram illustrating a relationship between an infrared transmission amount and the exposure period in the first camera CA3 and the second camera CA4. FIG. 24 is a diagram illustrating exposure amounts of visible light of the first camera CA3 and the second camera CA4.

For example, the infrared transmission amount detected by the photodetector PD of the pixel PX6 of the second camera CA4 is smaller than the infrared transmission amount detected by the photodetector PD of the pixel PX5 of the first camera CA3. When the ratio of the infrared transmission amounts of the two cameras CA (the infrared transmission amount of the second camera CA4/the infrared transmission amount of the first camera CA3) is Q, for example, the exposure control unit ETC sets the exposure period of the second camera CA4 to be longer than the exposure period of the first camera CA3 by 1/Q times. Therefore, the infrared detection value of pixel PX6 is equal to the infrared detection value of pixel PX5. The exposure amount of the visible light of the pixels PX1, PX2, and PX3 is larger in the second camera CA4 than in the first camera CA3.

Returning to FIG. 22, the image data acquisition unit IDO acquires, from the plurality of cameras CA, a plurality of pieces of image data captured under different exposure conditions. Each of the plurality of pieces of image data includes visible light image information and infrared image information. The image data acquisition unit IDO outputs the plurality of pieces of image data to the infrared image extraction unit IRE and a visible light image extraction unit VLE6.

The infrared image extraction unit IRE extracts, from the plurality of pieces of image data, an infrared image for each piece of image data using infrared image information. The plurality of pieces of image data are captured under the exposure condition under which the detection value of the infrared of pixel PX5 is equal to the detection value of the infrared of pixel PX6. Therefore, the brightness levels of the plurality of infrared images extracted from the plurality of image data are equal to each other. The infrared image extraction unit IRE outputs the plurality of infrared images extracted from the plurality of image data to a depth information extraction unit DIE6. Using the active stereo method, the depth information extraction unit DIE6 extracts the depth information from the plurality of infrared images extracted by the infrared image extraction unit IRE.

Using visible light image information, the visible light image extraction unit VLE6 extracts a visible light image from a plurality of pieces of image data having different visible light exposure period, for each piece of image data. Unlike the first embodiment, the brightness levels of the plurality of extracted visible light images are different from each other. The visible light image extracted from the image data of the second camera CA4 is an image having a high brightness level (long accumulation image). The visible light image extracted from the image data of the first camera CA3 is an image having a low brightness level (short accumulation image). Hereinafter, the second camera CA4 that acquires a long accumulation image may be referred to as a long accumulation camera, and the first camera CA3 that acquires a short accumulation image may be referred to as a short accumulation camera. The visible light image extraction unit VLE 6 outputs a plurality of visible light images (long accumulation image, short accumulation image) extracted from a plurality of pieces of image data to the combining unit IMC.

The combining unit IMC combines a plurality of visible light images (long accumulation image, short accumulation image) extracted from a plurality of pieces of image data. The combining unit IMC first detects parallax of the plurality of cameras CA based on the plurality of visible light images. The combining unit IMC corrects a position shift due to parallax of the plurality of visible light images (warping process). Next, the combining unit IMC combines a plurality of visible light images in which the position shift due to parallax has been corrected (combining process).

The long accumulation image is an image captured with a long exposure period. Therefore, the color reproducibility of the low gradation region is high. The short accumulation image is an image captured with a short exposure period. Therefore, the color reproducibility of the high gradation region is high. The combining unit IMC generates a visible light image (combined image) having a wide dynamic range based on gradation information regarding the low gradation region extracted from the long accumulation image and the gradation information regarding the high gradation region extracted from the short accumulation image.

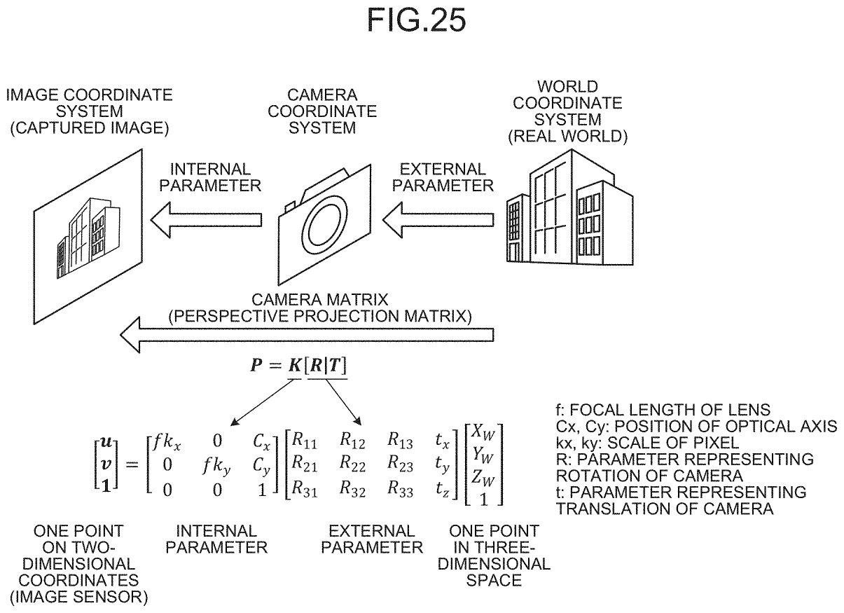

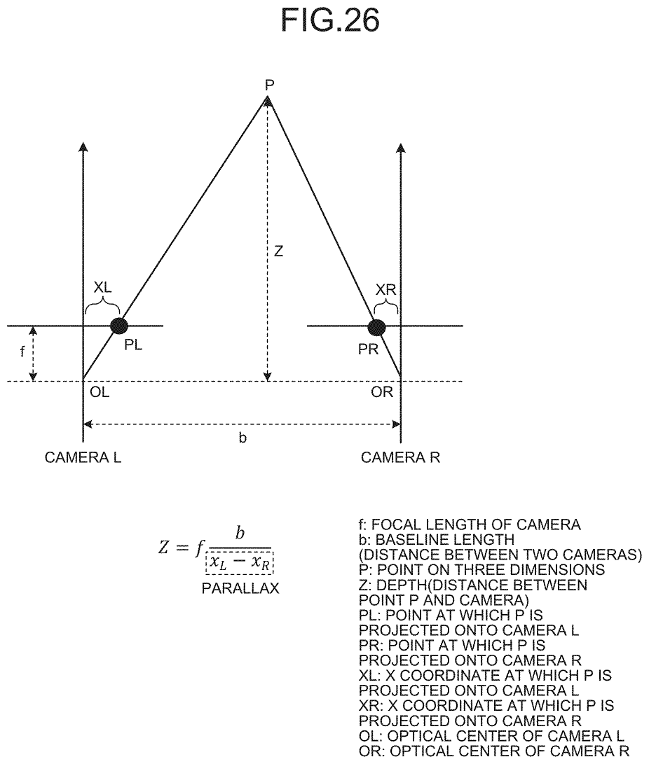

FIGS. 25 and 26 are diagrams illustrating an example of a warping process. FIG. 25 is a diagram illustrating a perspective projection model. FIG. 26 is a diagram illustrating a warping process.

Examples of the warping process include a method using a perspective projection model and depth information. With this method, the position shift can be corrected without performing matching such as block matching.

The perspective projection model is a model for converting world coordinates (X_{W}, Y_{W}, Z_{W}) into image coordinates (u, v). In FIG. 25, P and (u, v) indicate coordinates of a point projected onto an image plane. K represents an internal parameter matrix. The internal parameter matrix K describes which optical system (lens) is used to capture an image. (Cₓ, C_{y}) indicates a principal point (typically indicating a position of an optical axis at an image center). fkₓ and fk_{y} indicate focal lengths expressed in units of pixels. [R|T] represents an external parameter matrix. The external parameter matrix [R|T] describes where and in which direction the camera CA is installed. R is a parameter representing the rotation of the camera CA. T is a parameter representing translation of the camera CA.

The parameters (internal parameters) of the internal parameter matrix K and the parameters (external parameters) of the external parameter matrix [R|T] can be estimated by using calibration charts captured from a plurality of viewpoints (refer to the Zhang approach described in http://staff.fh-hagenberg.at/burger/publications/reports/2016Calibration/Burger-CameraCalibration-20160516.pdf), for example.

Using the internal parameter and the external parameter determined by camera calibration, the plurality of visible light images can be directed straight ahead with respect to the subject (front orientation). With this operation, the epipolar line extends in the horizontal direction, and the influence of parallax (the direction needing the warping process) is only in the horizontal direction (X-axis direction). Although there might be a necessity to remove the influence of the lens distortion in practice, the influence of the lens distortion can be ignored when the image is assumed to be an image of a pinhole camera.

When the front orientation performed using the internal parameter and the external parameter of the perspective projection model and when the depth information Z is known, the amount of parallax (X_{L}-X_{R}) of the plurality of cameras CA can be obtained using the triangulation method illustrated in FIG. 26. By moving the visible light image extracted from the image data of a non-reference camera (second camera CA4) by the amount of parallax, it is possible to generate a visible light image apparently captured at the same viewpoint as the reference image.

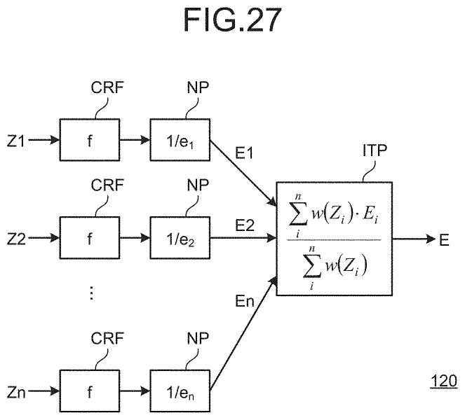

FIG. 27 is a conceptual diagram of a combining process.

The combining unit IMC performs combining using a generally known method (refer to “Radiometric Self Calibration”, Tomoo Mitsunaga, etc., for example). Reference numerals Z1, Z2, Z3, . . . Zn denote pixel values. Reference numeral n denotes the number of cameras CA (the number of visible light images). Each pixel value undergoes processing for returning a nonlinear image signal to a linear signal by a camera response function CRF. When the input is a linear signal, there is no need to perform processing by the camera response function CRF.

Normalization of the brightness level is performed as a process of adjusting the brightness to a specific reference (long accumulation image or short accumulation image). Normalization is performed to equalize the brightness levels of the long accumulation image and the short accumulation image. With this process, the dynamic range is extended downward in the long accumulation image, and the dynamic range is extended upward in the short accumulation image. An addition unit ITP performs processing of adding the normalized brightness levels E1, E2, . . . , and En by the expression illustrated in FIG. 27. With this operation, the long accumulation image and the short accumulation image are combined to generate a visible light image (combined image) with an extended dynamic range. Based on the depth information, the processing unit IMP processes the visible light image (combined image) generated by the combining unit IMC.

A storage device ST6 stores a program PG6 executed by the processing device PU6, for example. The program PG6 is a program that causes a computer to execute information processing according to the present embodiment. The processing device PU6 performs various types of processing according to the program PG6 stored in the storage device ST6. By executing the program PG6, the processing device PU6 functions as the image data acquisition unit IDO, the infrared image extraction unit IRE, the visible light image extraction unit VLE6, the depth information extraction unit DIE6, the combining unit IMC, the processing unit IMP, the output unit OT, and the exposure control unit ETC.

[7-2. Information Processing Method]

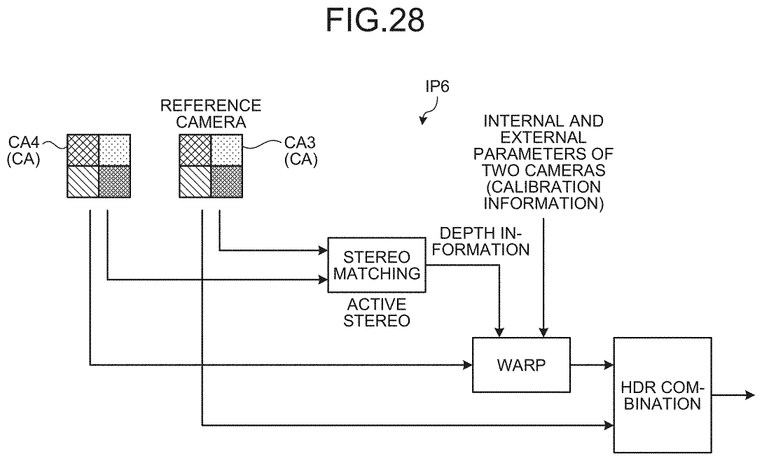

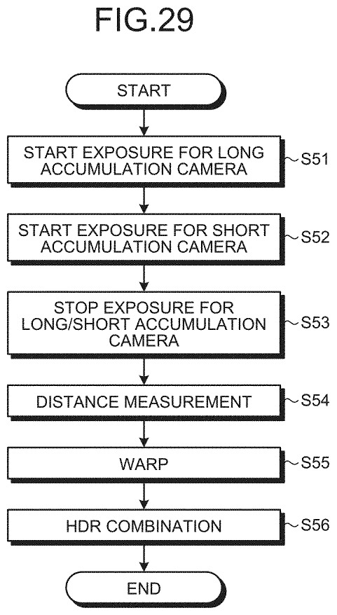

FIGS. 28 and 29 are diagrams illustrating an example of an information processing method of the present embodiment. FIG. 28 is a conceptual diagram of information processing. FIG. 29 is a flowchart illustrating an information processing method.

In step S51, the exposure control unit ETC starts exposure with the long accumulation camera (second camera CA4). In step S52, the exposure control unit ETC starts exposure with the short accumulation camera (first camera CA3). In step S53, the exposure control unit ETC stops the exposure with the long accumulation camera and the short accumulation camera.

For example, the exposure control unit ETC controls to vary the exposure periods of the plurality of image sensors IS in accordance with the sensitivity of the infrared of the plurality of image sensors IS. The exposure control unit ETC increases the exposure period of the long accumulation camera having low infrared sensitivity so as to bring the brightness level of the infrared image detected by the long accumulation camera to match the brightness level of the infrared image detected by the short accumulation camera.

The image data acquisition unit IDO acquires a plurality of pieces of image data captured by the plurality of cameras CA. The infrared image extraction unit IRE extracts, from the plurality of pieces of image data, an infrared image for each piece of image data using infrared image information. The visible light image extraction unit VLE6 extracts, from a plurality of pieces of image data, a visible light image using visible light image information for each piece of image data.

In step S54, the depth information extraction unit DIE6 extracts the depth information by an active stereo method using the plurality of infrared images extracted by the infrared image extraction unit IRE.

In step S55, the combining unit IMC performs a warping process on the non-reference image and corrects the position shift due to parallax of the plurality of visible light images. In step S56, the combining unit IMC performs a combining process on the plurality of visible light images in which the position shift due to the parallax has been corrected. Thereafter, based on the depth information, the processing unit IMP processes the visible light image (combined image) obtained by the combining process.

[7-3. Effects]

The information processing apparatus IP6 includes the visible light image extraction unit VLE6 and the combining unit IMC. Using visible light image information, the visible light image extraction unit VLE6 extracts a visible light image from a plurality of pieces of image data having different visible light exposure period, for each piece of image data. The combining unit IMC combines a plurality of visible light images extracted from a plurality of pieces of image data.

According to this configuration, a visible light image (combined image) having a wide dynamic range is generated.

The plurality of image sensors IS has mutually different sensitivity to infrared. The information processing apparatus IP6 includes an exposure control unit ETC. For example, the exposure control unit ETC controls to vary the exposure periods of the plurality of image sensors IS in accordance with the sensitivity of the infrared of the plurality of image sensors IS.

With this configuration, a plurality of pieces of visible light image information having different exposure periods is acquired with execution of the active stereo mode. This makes it possible to easily generate a visible light image with a wide dynamic range.

### 8. Seventh Embodiment

[8-1. Configuration of Information Processing Apparatus]

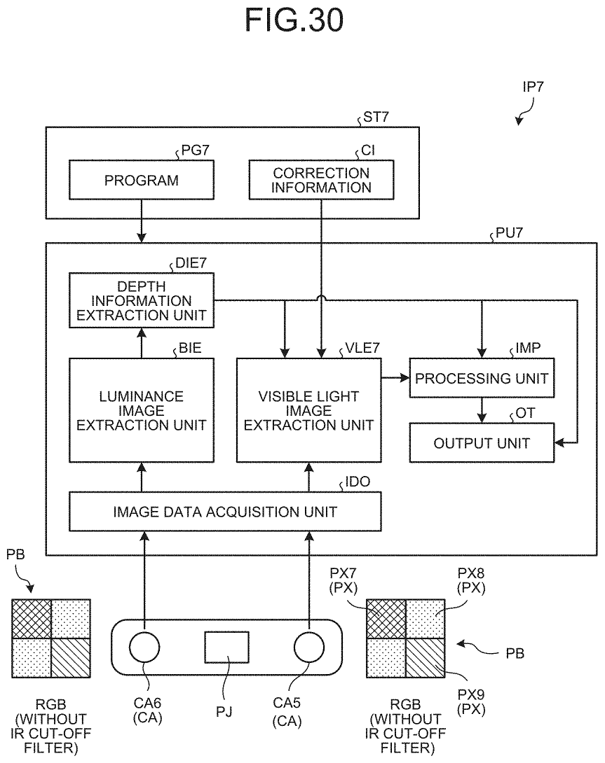

FIG. 30 is a schematic diagram of an information processing apparatus IP7 according to the seventh embodiment.

The present embodiment is different from the first embodiment in that a plurality of pixels PX for detecting both visible light and infrared is two-dimensionally arranged. There is no special pixel PX (pixel PX4 of the first embodiment) for detecting infrared, and infrared are detected in all the pixels PX. Hereinafter, differences from the first embodiment will be mainly described.

The image sensor IS includes a plurality of pixel blocks PB arranged two-dimensionally, for example. Each of the plurality of pixel blocks PB has a structure in which one pixel PX7, two pixels PX8, and one pixel PX9 are arranged in a 2-row by 2-column pixel pattern. The pixel PX7 detects red light and infrared, for example. The pixel PX8 detects green light and infrared, for example. The pixel PX9 detects blue light and infrared, for example.

The image data acquisition unit IDO acquires, from a plurality of cameras CA, a plurality of pieces of image data captured from a plurality of viewpoints. Each of the plurality of pieces of image data includes information regarding the total amount of received light regarding visible light and infrared, for each pixel PX, as visible light image information and infrared image information. The image data acquisition unit IDO outputs the plurality of pieces of image data to a luminance image extraction unit BIE and a visible light image extraction unit VLE7.

For example, the depth information is extracted from a plurality of luminance images indicating the distribution of the total amount of received light. A processing device PU7 includes the luminance image extraction unit BIE instead of the infrared image extraction unit IRE used in the first embodiment.

For example, the luminance image extraction unit BIE extracts, from a plurality of pieces of image data, a luminance image including both infrared image information and visible light image information for each piece of image data. The luminance image includes only luminance information indicating the detection value of each pixel PX and does not include color information. The luminance image extraction unit BIE outputs the plurality of luminance images extracted from the plurality of pieces of image data to a depth information extraction unit DIE7.

The depth information extraction unit DIE7 extracts depth information from the plurality of luminance images output from the luminance image extraction unit BIE. The luminance image includes infrared image information indicating an infrared projection pattern. The luminance image includes a detection value of visible light as a noise component. However, when the infrared intensity of the projector PJ is high, the detection value of the infrared becomes larger than the detection value of the visible light, and the shape of the infrared projection pattern will clearly appear in the luminance image. Therefore, depth information extraction unit DIE7 can extract the depth information from the plurality of pieces of infrared image information included in the plurality of pieces of image data. The depth information extraction unit DIE7 outputs the depth information as a depth map to the visible light image extraction unit VLE7, the processing unit IMP, and the output unit OT.

The visible light image extraction unit VLE7 separates the infrared image information and the visible light image information from each other, for example. The visible light image extraction unit VLE7 extracts a visible light image from the visible light image information obtained by the separation. For example, the visible light image extraction unit VLE7 extracts a visible light image for each piece of image data from a plurality of pieces of image data. The visible light image extraction unit VLE7 outputs at least one visible light image among a plurality of visible light images extracted from the plurality of pieces of image data to the processing unit IMP.

For example, the visible light image extraction unit VLE7 estimates distribution information regarding the infrared projection pattern appearing in the image using the depth information and correction information CI. The visible light image extraction unit VLE7 separates the infrared image information and the visible light image information from each other based on the distribution information.

The correction information CI includes, for example, calibration information between the camera CA and the projector PJ (including information regarding the focal length and the baseline length of the camera CA). The correction information CI includes information regarding a mode of attenuation and scattering of infrared according to the distance, for example. The correction information CI includes infrared projection pattern information (including information regarding the shape and position of the infrared projection pattern), for example. The correction information CI includes, for example, information related to a degradation process such as blurring of the infrared projection pattern due to the lens of the projector PJ. The correction information CI includes, for example, information regarding a color conversion matrix for correcting color shift caused by ambient light.

For example, using the depth information and the calibration information, the visible light image extraction unit VLE7 estimates a position where the infrared projection pattern is to be projected. The position is specified using the triangulation method illustrated in FIG. 26. The projector PJ can also be handled as the same perspective projection model as the camera CA. Therefore, the infrared projection pattern of the projector PJ can be warped to the viewpoint of the reference camera by the same method as the warping process described in the sixth embodiment. However, in the case of the projector PJ, unlike the camera CA, it is not possible to directly estimate the parameter by capturing an image of a pattern board. Therefore, the calibration is indirectly performed using the camera CA by the method disclosed in https://www.jstage.jst.go.jp/article/itej/62/12/62_12_1964/_pdf/-char/ja, for example.

The visible light image extraction unit VLE7 estimates the shape of the infrared projection pattern appearing in the image in consideration of the power of the projector PJ, the mode of attenuation and scattering of infrared depending on the distance, and the degradation process such as blurring due to the lens, for example. The visible light image extraction unit VLE7 estimates the position and shape of the infrared projection pattern obtained by the calculation as the distribution information regarding the infrared projection pattern.

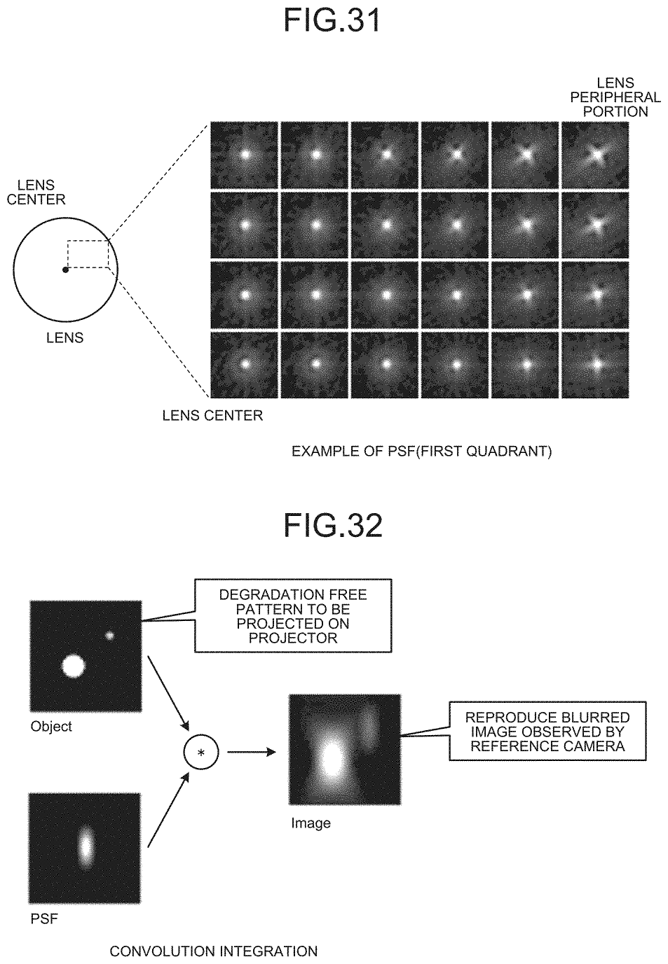

FIGS. 31 and 32 are diagrams illustrating a method of applying blur (degradation) to a dot pattern.

The user measures a point spread function (PSF) of the projector PJ in advance. The PSF changes in shape for each image height of the lens of the projector PJ. Therefore, the user performs measurement for each image height. After measurement of the first quadrant alone, symmetrical values can be used for the remaining three quadrants. By performing convolution integration of the measured PSF and the infrared projection pattern projected by the projector PJ, it is possible to reproduce a blurred image. As illustrated in FIG. 31, although the blur is small in the central portion of the lens, the blur is large with a unique shape in the peripheral portion of the lens.

For example, the visible light image extraction unit VLE7 performs a correction process on the visible light image information separated from the infrared image information. The correction process is a process of correcting a color shift caused by infrared included in ambient light.

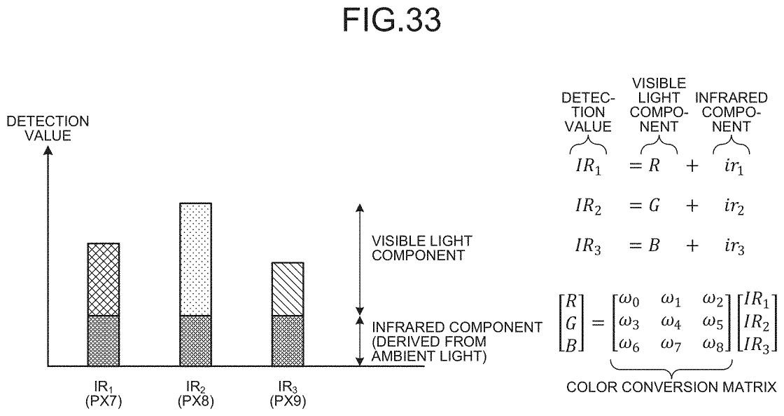

FIG. 33 is a diagram illustrating a correction process.

The pixel PX detects the total amount of received light regarding the visible light and infrared. Therefore, when the demosaicing is performed on the detection value of each pixel PX, the red, green, and blue color values of each pixel PX are raised by the detection value of the infrared. Even when the infrared component derived from the infrared projection pattern is separated by the above-described process, the infrared component derived from the ambient light would not be separated. Therefore, the visible light image extraction unit VLE7 corrects the color shift derived from the ambient light using a color conversion matrix.

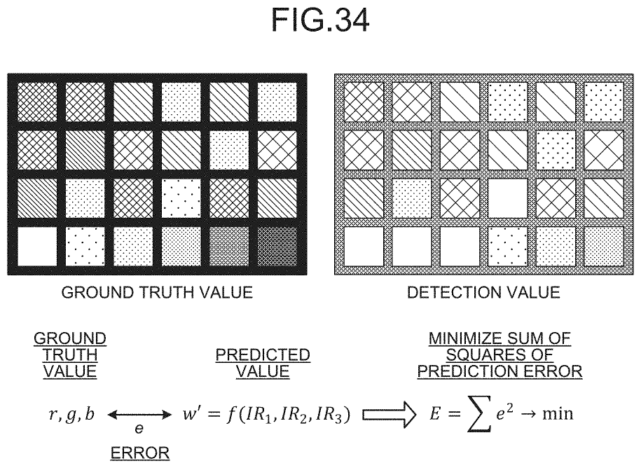

FIG. 34 is a diagram illustrating an example of a method of calculating a color conversion matrix.

The color conversion matrix is calculated, for example, by the following method. First, the user uses the camera CA to capture a Macbeth chart that provides ground truth colors. A user uses a computer to obtain a color conversion matrix having parameters ω₀ to ωₛ that minimize a square error between a detection value and a ground truth value.

Returning to FIG. 30, a storage device ST7 stores, for example, a program PG7 and correction information CI executed by the processing device PU7. The program PG7 is a program that causes a computer to execute information processing according to the present embodiment. The processing device PU7 performs various types of processing according to the program PG7 stored in the storage device ST7. By executing the program PG7, the processing device PU7 functions as the image data acquisition unit IDO, the luminance image extraction unit BIE, the visible light image extraction unit VLE7, the depth information extraction unit DIET, the processing unit IMP, and the output unit OT.

[8-2. Information Processing Method]

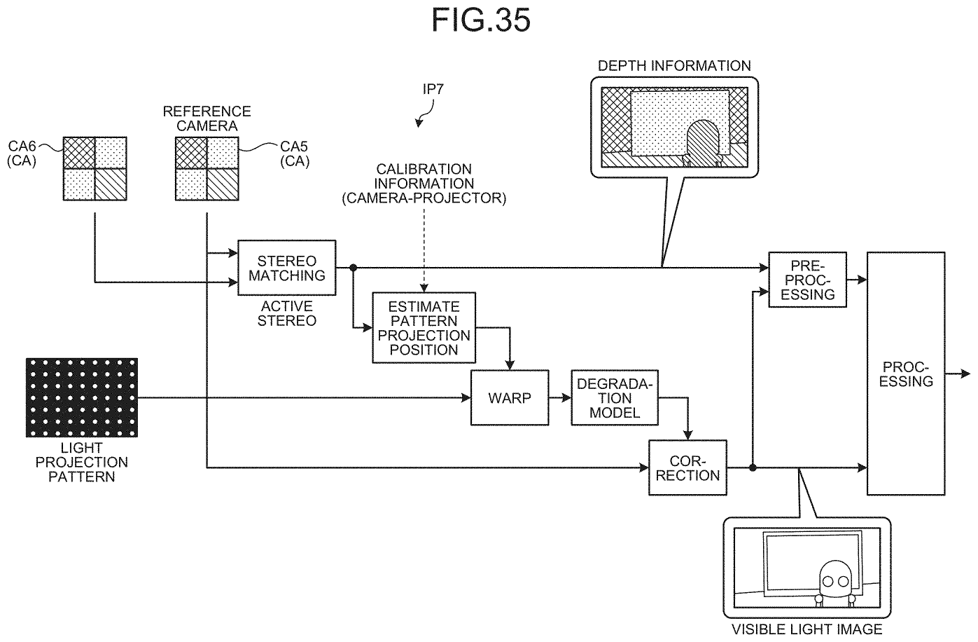

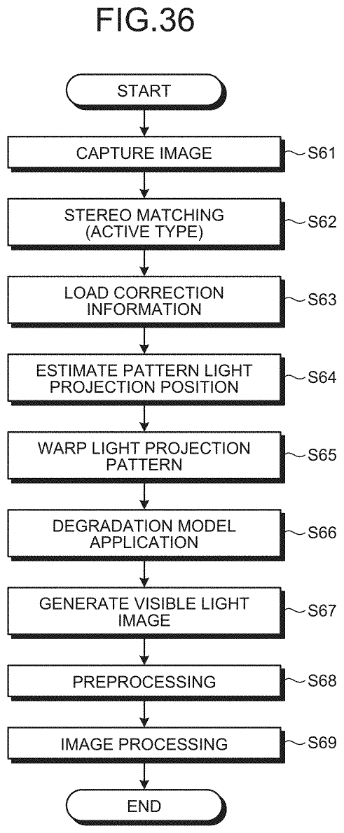

FIGS. 35 and 36 are diagrams illustrating an example of an information processing method of the present embodiment. FIG. 35 is a conceptual diagram of information processing. FIG. 36 is a flowchart illustrating an information processing method.

In step S61, the plurality of cameras CA captures the subject from a plurality of viewpoints. The image data acquisition unit IDO acquires a plurality of pieces of image data captured from a plurality of viewpoints.

In step S62, the luminance image extraction unit BIE extracts, from the plurality of pieces of image data, a luminance image including both infrared image information and visible light image information for each piece of image data. The depth information extraction unit DIET uses the active stereo method to extract depth information from the plurality of luminance images extracted from the plurality of image data.

In step S63, the visible light image extraction unit VLE7 acquires the correction information CI from the storage device ST7.

In step S64, based on the depth information and the correction information CI, the visible light image extraction unit VLE7 estimates a position where the infrared projection pattern is to be projected.

In step S65, using the infrared projection pattern information included in the correction information CI, the visible light image extraction unit VLE7 superimposes the infrared projection pattern on the position within the reference camera image estimated in step S64.

In step S66, using the information regarding the degradation process included in the correction information CI, the visible light image extraction unit VLE7 applies a degradation model to the infrared projection pattern and estimates the distribution information regarding the infrared projection pattern.

In step S67, the visible light image extraction unit VLE7 separates the visible light image information and the infrared image information included in the image data based on the distribution information estimated in step S66. The visible light image extraction unit VLE 7 performs a correction process of correcting a color shift caused by the infrared included in ambient light on the visible light image information separated from the infrared image information. The visible light image extraction unit VLE7 generates a visible light image by using the visible light image information separated from the infrared image information.

In step S68, the processing unit IMP performs preprocessing on the visible light image acquired from the visible light image extraction unit VLE1. This visible light image is a reference image generated using visible light image information included in image data of the first camera CA5 (reference camera).

In step S69, the processing unit IMP performs image processing based on the depth information on the preprocessed visible light image.

[8-3. Effect]

Each of the plurality of pieces of image data includes, for each pixel, information regarding the total amount of received light regarding visible light and infrared as visible light image information and infrared image information.

With this configuration, infrared are detected in all the pixels. This increases the sensitivity to infrared. Because of high density of pixels for detecting infrared, aliasing is less likely to occur.

The visible light image extraction unit VLE7 separates the infrared image information and the visible light image information from each other. The visible light image extraction unit VLE7 extracts a visible light image from the visible light image information obtained by the separation.

This configuration makes it possible to obtain a visible light image not including a noise component caused by infrared image information.

The visible light image extraction unit VLE7 estimates distribution information regarding the infrared projection pattern appearing in the image. The visible light image extraction unit VLE7 separates the infrared image information and the visible light image information from each other based on the distribution information.

With this configuration, the infrared image information and the visible light image information are separated from each other with high accuracy.

The visible light image extraction unit VLE 7 performs a correction process of correcting a color shift caused by the infrared included in ambient light on the visible light image information separated from the infrared image information.

This configuration makes it possible to obtain a visible light image with high color reproducibility.

### 9. Eighth Embodiment

[9-1. Configuration of Information Processing Apparatus]

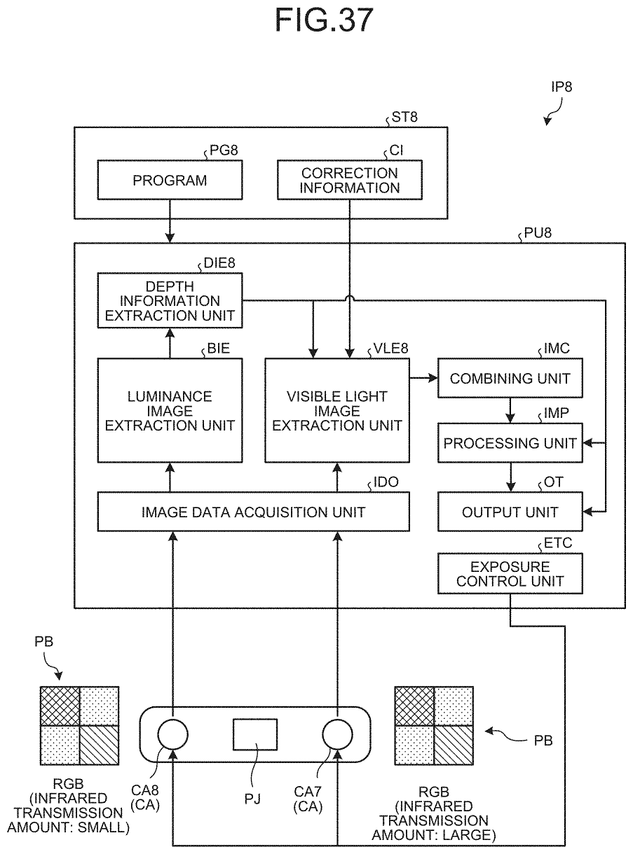

FIG. 37 is a schematic diagram of an information processing apparatus IP8 according to the eighth embodiment.

The present embodiment is different from the seventh embodiment in that the infrared sensitivity of the plurality of cameras CA is different, the exposure period of the plurality of cameras CA is different according to the infrared sensitivity, and a processing device PU8 includes a combining unit IMC that combines a plurality of visible light images having different exposure periods. The present embodiment is similar to the sixth embodiment in that a combined image having a wide dynamic range is generated by combining a plurality of visible light images having mutually different exposure periods. Hereinafter, differences from the sixth embodiment and the seventh embodiment will be mainly described.

In the seventh embodiment, the plurality of image sensors IS included in the plurality of cameras CA all have the same structure. In the present embodiment, the infrared sensitivity of the plurality of image sensors IS is different from each other. For example, each pixel PX of one or more cameras CA is provided with an infrared cut filter. The infrared cut filter absorbs a part of infrared incident on the pixel PX.

The processing device PU8 includes an exposure control unit ETC as disclosed in the sixth embodiment, for example. For example, the exposure control unit ETC controls to vary the exposure periods of the plurality of image sensors IS in accordance with the sensitivity of the infrared of the plurality of image sensors IS, for example. The lower the sensitivity of the image sensor IS to infrared, the longer the exposure period set by the exposure control unit ETC. With this setting, the exposure control unit ETC equalizes the levels of brightness of the infrared images detected by the plurality of image sensors.

For example, the infrared transmission amount detected by the photodetector PD of the pixel PX of the second camera CA8 is smaller than the infrared transmission amount detected by the photodetector PD of the pixel PX of the first camera CA7. When the ratio of the infrared transmission amounts of the two cameras CA (the infrared transmission amount of the second camera CA8/the infrared transmission amount of the first camera CA7) is Q, for example, the exposure control unit ETC sets the exposure period of the second camera CA8 to be longer than the exposure period of the first camera CA7 by 1/Q times. This makes the detection value of the infrared of the pixel PX to be equal between the first camera CA1 and the second camera CA2. The exposure amount of the visible light of the pixel PX is larger in the second camera CA8 than in the first camera CA7.

The image data acquisition unit IDO acquires a plurality of pieces of image data captured under different exposure conditions from the plurality of cameras CA. Each of the plurality of pieces of image data includes information regarding the total amount of received light regarding visible light and infrared, for each pixel PX, as visible light image information and infrared image information. The image data acquisition unit IDO outputs the plurality of pieces of image data to a luminance image extraction unit BIE and a visible light image extraction unit VLE8.

For example, the luminance image extraction unit BIE extracts, from a plurality of pieces of image data, a luminance image including both infrared image information and visible light image information for each piece of image data. A depth information extraction unit DIE8 extracts depth information from the plurality of luminance images output from the luminance image extraction unit BIE. The depth information extraction unit DIE8 outputs the depth information as a depth map to the visible light image extraction unit VLE8, the processing unit IMP, and the output unit OT.

The visible light image extraction unit VLE8 separates the infrared image information and the visible light image information from each other by the method described in the seventh embodiment, for example. The visible light image extraction unit VLE8 extracts the visible light image from the visible light image information obtained by the separation. For example, the visible light image extraction unit VLE7 extracts a visible light image for each piece of image data from a plurality of pieces of image data having different exposure periods of visible light. The brightness levels of the plurality of extracted visible light images are different from each other. The visible light image extracted from the image data of the second camera CA8 is an image having a high brightness level (long accumulation image). The visible light image extracted from the image data of the first camera CA7 is an image having a low brightness level (short accumulation image). The visible light image extraction unit VLE 6 outputs a plurality of visible light images (long accumulation image, short accumulation image) extracted from a plurality of pieces of image data to the combining unit IMC.

The combining unit IMC combines a plurality of visible light images (long accumulation image, short accumulation image) extracted from a plurality of pieces of image data. The combining method is the same as that described in the sixth embodiment.

A storage device ST8 stores a program PG8 and correction information CI executed by the processing device PU8, for example. The program PG8 is a program that causes a computer to execute information processing according to the present embodiment. The processing device PU8 performs various types of processing according to the program PG8 stored in the storage device ST8. By executing the program PG8, the processing device PU8 functions as the image data acquisition unit IDO, the luminance image extraction unit BIE, the visible light image extraction unit VLE8, a depth information extraction unit DIE8, the combining unit IMC, the processing unit IMP, the output unit OT, and the exposure control unit ETC.

[9-2. Information Processing Method]

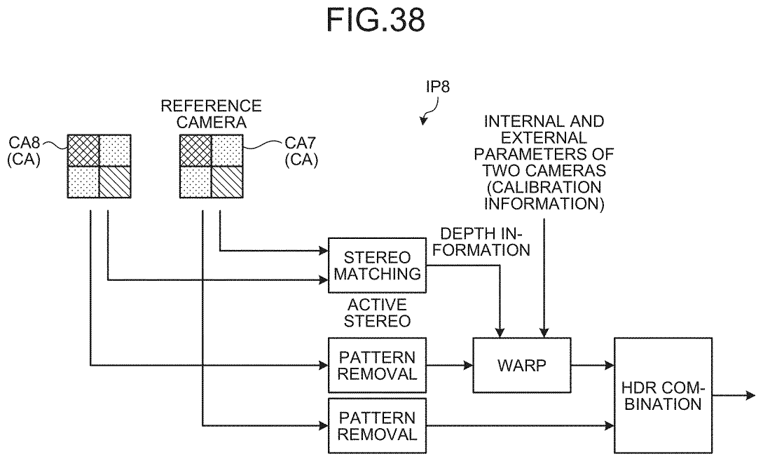

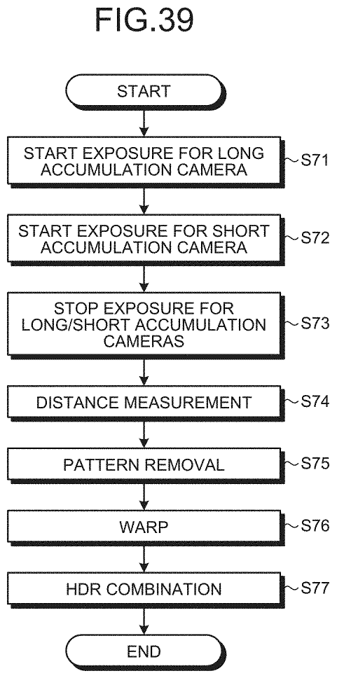

FIGS. 38 and 39 are diagrams illustrating an example of an information processing method of the present embodiment. FIG. 38 is a conceptual diagram of information processing. FIG. 39 is a flowchart illustrating an information processing method.

In step S71, the exposure control unit ETC starts exposure with the long accumulation camera (second camera CA8). In step S72, the exposure control unit ETC starts exposure with the short accumulation camera (first camera CA7). In step S73, the exposure control unit ETC stops the exposure with the long accumulation camera and the short accumulation camera.

For example, the exposure control unit ETC controls to vary the exposure periods of the plurality of image sensors IS in accordance with the sensitivity of the infrared of the plurality of image sensors IS. The exposure control unit ETC increases the exposure period of the long accumulation camera having low infrared sensitivity so as to bring the brightness level of the infrared image detected by the long accumulation camera to match the brightness level of the infrared image detected by the short accumulation camera.

In step S74, the image data acquisition unit IDO acquires a plurality of pieces of image data captured by the plurality of cameras CA. The luminance image extraction unit BIE extracts, from a plurality of pieces of image data, a luminance image including both infrared image information and visible light image information for each piece of image data. The depth information extraction unit DIE8 uses the active stereo method to extract depth information from the plurality of luminance images extracted from the plurality of image data.

In step S75, the visible light image extraction unit VLE8 extracts a visible light image from a plurality of pieces of image data having different exposure periods of visible light for each piece of the image data. First, the visible light image extraction unit VLE8 estimates distribution information regarding the infrared projection pattern appearing in the image. The visible light image extraction unit VLE8 separates the infrared image information and the visible light image information included in the image data based on the distribution information. The visible light image extraction unit VLE8 performs a correction process of correcting a color shift caused by an infrared included in ambient light on the visible light image information separated from the infrared image information. The visible light image extraction unit VLE8 extracts the visible light image from the visible light image information obtained by the separation.

In step S76, the combining unit IMC performs a warping process on the non-reference image and corrects position shift due to parallax of the plurality of visible light images. In step S77, the combining unit IMC performs a combining process on the plurality of visible light images in which the position shift due to the parallax has been corrected. Thereafter, based on the depth information, the processing unit IMP processes the visible light image (combined image) obtained by the combining process.

[9-3. Effects]

The visible light image extraction unit VLE8 extracts a visible light image for each piece of image data from a plurality of pieces of image data having different exposure periods of visible light. The combining unit IMC combines a plurality of visible light images extracted from a plurality of pieces of image data.

According to this configuration, a visible light image having a wide dynamic range is generated.

The plurality of image sensors IS has mutually different sensitivity to infrared. For example, the exposure control unit ETC controls to vary the exposure periods of the plurality of image sensors IS in accordance with the sensitivity of the infrared of the plurality of image sensors IS.

With this configuration, a plurality of pieces of visible light image information having different exposure periods is acquired with execution of the active stereo mode. This makes it possible to easily generate a visible light image with a wide dynamic range.

The effects described in the present specification are merely examples, and thus, there may be other effects, not limited to the exemplified effects.

Note that the present technique can also have the following configurations.

(1)

An information processing apparatus comprising:

a depth information extraction unit capable of extracting depth information from a plurality of pieces of infrared image information included in a plurality of pieces of image data captured at a plurality of viewpoints, the plurality of pieces of image data each including visible light image information and infrared image information; and

a processing unit that processes, based on the depth information, a visible light image generated by using the visible light image information included in at least one piece of image data among the plurality of pieces of image data.

(2)

The information processing apparatus according to (1),

wherein the depth information extraction unit switches modes between a passive stereo mode in which the depth information is extracted from a plurality of pieces of visible light image information included in the plurality of pieces of image data and an active stereo mode in which the depth information is extracted from a plurality of pieces of infrared image information included in the plurality of pieces of image data, the switching being performed in accordance with a situation.

(3)

The information processing apparatus according to (2),

wherein the depth information extraction unit switches modes between the passive stereo mode and the active stereo mode in accordance with a situation based on a distance from a subject.

(4)

The information processing apparatus according to (2) or (3),

wherein the depth information extraction unit switches modes between the passive stereo mode and the active stereo mode in accordance with a situation based on an image capturing scene.

(5)

The information processing apparatus according to any one of (2) to (4),

comprising a pattern control unit that changes an infrared projection pattern used in the active stereo mode, the changing being performed in accordance with a distance from a subject.

(6)

The information processing apparatus according to any one of (1) to (5), comprising

a plurality of image sensors that each captures each of the plurality of pieces of image data,

wherein each of the plurality of image sensors has a structure in which a plurality of pixels for detecting the visible light image information and a plurality of pixels for detecting the infrared image information are periodically arranged in a two-dimensional direction.

(7)

The information processing apparatus according to (6),

wherein each of the plurality of image sensors includes a plurality of pixel blocks arranged two-dimensionally, and

each of the plurality of pixel blocks has a structure in which one pixel for detecting red light, one pixel for detecting green light, one pixel for detecting blue light, and one pixel for detecting infrared are arranged in a 2-row by 2-column pixel pattern.

(8)

The information processing apparatus according to (6),

wherein each of the plurality of image sensors has a structure in which a plurality of first pixel blocks and a plurality of second pixel blocks are periodically arranged in a two-dimensional direction,

each of the plurality of first pixel blocks has a structure in which one pixel for detecting red light, one pixel for detecting green light, and two pixels for detecting infrared are arranged in a 2-row by 2-column pixel pattern, and

each of the plurality of second pixel blocks has a structure in which one pixel for detecting green light, one pixel for detecting blue light, and two pixels for detecting infrared are arranged in a 2-row by 2-column pixel pattern.

(9)

The information processing apparatus according to (6),

wherein each of the plurality of image sensors includes a plurality of pixel blocks that detects infrared, and

each of the plurality of pixel blocks that detects infrared has a structure in which a plurality of pixels that detects infrared is arranged adjacent to each other.

(10)

The information processing apparatus according to (6),

wherein each of the plurality of image sensors includes a plurality of pixel blocks arranged two-dimensionally,

each of the plurality of pixel blocks includes a plurality of pixels arranged adjacent to each other, and

each of the plurality of image sensors has a structure in which a plurality of pixel blocks to which red is allocated, a plurality of pixel blocks to which green is allocated, a plurality of pixel blocks to which blue is allocated, and a plurality of pixel blocks to which infrared are allocated are periodically arranged in a two-dimensional direction.

(11)

The information processing apparatus according to (1), comprising:

a visible light image extraction unit that extracts a visible light image using the visible light image information from the plurality of pieces of image data having different exposure periods of visible light, for each piece of image data; and

a combining unit that combines a plurality of visible light images extracted from the plurality of pieces of image data.

(12)

The information processing apparatus according to (11), comprising

a plurality of image sensors that captures each of the plurality of pieces of image data,

wherein each of the plurality of image sensors has a structure in which a plurality of pixels for detecting visible light image information and a plurality of pixels for detecting infrared image information are periodically arranged in a two-dimensional direction,

sensitivity of the plurality of image sensors to infrared is different from each other, and

the information processing apparatus comprises an exposure control unit that controls to vary exposure periods of the plurality of image sensors in accordance with the sensitivity of each of the plurality of image sensors to infrared.

(13)

The information processing apparatus according to (1),

wherein each of the plurality of pieces of image data includes information regarding a total amount of received light regarding visible light and infrared, for each pixel, as the visible light image information and the infrared image information.

(14)

The information processing apparatus according to (13), comprising

a visible light image extraction unit that separates the infrared image information and the visible light image information from each other, and extracts a visible light image from the visible light image information obtained by the separation.

(15)

The information processing apparatus according to (14),

wherein the visible light image extraction unit estimates distribution information regarding an infrared projection pattern appearing in an image, and separates the infrared image information and the visible light image information from each other based on the distribution information.

(16)

The information processing apparatus according to (15),

wherein the visible light image extraction unit extracts the visible light image from the plurality of pieces of image data having different exposure periods of visible light, for each piece of image data, and

the information processing apparatus comprises a combining unit that combines a plurality of visible light images extracted from the plurality of pieces of image data.

(17)

The information processing apparatus according to (16), comprising

a plurality of image sensors that captures each of the plurality of pieces of image data,

wherein each of the plurality of image sensors has a structure in which a plurality of pixels that detects both visible light and infrared are two-dimensionally arranged,

sensitivity of the plurality of image sensors to infrared is different from each other, and

the information processing apparatus comprises an exposure control unit that controls to vary exposure periods of the plurality of image sensors in accordance with the sensitivity of each of the plurality of image sensors to infrared.

(18)

The information processing apparatus according to (17),

wherein the visible light image extraction unit performs a correction process of correcting a color shift caused by infrared included in ambient light, the correction process being performed on the visible light image information separated from the infrared image information.

(19)

An information processing method to be executed by a computer, the method comprising:

acquiring a plurality of pieces of image data captured at a plurality of viewpoints, the plurality of pieces of image data each including visible light image information and infrared image information;

extracting depth information from a plurality of pieces of infrared image information included in the plurality of pieces of image data; and

processing, based on the depth information, a visible light image generated by using the visible light image information included in at least one piece of image data among the plurality of pieces of image data.

(20)

A program that causes a computer to execute processes comprising:

acquiring a plurality of pieces of image data captured at a plurality of viewpoints, the plurality of pieces of image data each including visible light image information and infrared image information;

extracting depth information from a plurality of pieces of infrared image information included in the plurality of pieces of image data; and

processing, based on the depth information, a visible light image generated by using the visible light image information included in at least one piece of image data among the plurality of pieces of image data.

### REFERENCE SIGNS LIST

DIE1, DIE2, DIE3, DIE4, DIE5, DIE6, DIET, DIE8 DEPTH INFORMATION EXTRACTION UNIT
ETC EXPOSURE CONTROL UNIT
IMC COMBINING UNIT
IMP PROCESSING UNIT
IP1, IP2, IP3, IP4, IP5, IP6, IP7, IP8 INFORMATION PROCESSING APPARATUS
IS IMAGE SENSOR
PB PIXEL BLOCK
PTC PATTERN CONTROL UNIT
PX PIXEL
VLE1, VLE2, VLE3, VLE4, VLE5, VLE6, VLE7, VLE8 VISIBLE LIGHT IMAGE EXTRACTION UNIT

1. An information processing apparatus comprising:
a depth information extraction unit capable of extracting depth information from a plurality of pieces of infrared image information included in a plurality of pieces of image data captured at a plurality of viewpoints, the plurality of pieces of image data each including visible light image information and infrared image information; and
a processing unit that processes, based on the depth information, a visible light image generated by using the visible light image information included in at least one piece of image data among the plurality of pieces of image data.

2. The information processing apparatus according to claim 1,
wherein the depth information extraction unit switches modes between a passive stereo mode in which the depth information is extracted from a plurality of pieces of visible light image information included in the plurality of pieces of image data and an active stereo mode in which the depth information is extracted from a plurality of pieces of infrared image information included in the plurality of pieces of image data, the switching being performed in accordance with a situation.

3. The information processing apparatus according to claim 2,
wherein the depth information extraction unit switches modes between the passive stereo mode and the active stereo mode in accordance with a situation based on a distance from a subject.

4. The information processing apparatus according to claim 2,
wherein the depth information extraction unit switches modes between the passive stereo mode and the active stereo mode in accordance with a situation based on an image capturing scene.

5. The information processing apparatus according to claim 2,
comprising a pattern control unit that changes an infrared projection pattern used in the active stereo mode, the changing being performed in accordance with a distance from a subject.

6. The information processing apparatus according to claim 1, comprising
a plurality of image sensors that each captures each of the plurality of pieces of image data,
wherein each of the plurality of image sensors has a structure in which a plurality of pixels for detecting the visible light image information and a plurality of pixels for detecting the infrared image information are periodically arranged in a two-dimensional direction.

7. The information processing apparatus according to claim 6,
wherein each of the plurality of image sensors includes a plurality of pixel blocks arranged two-dimensionally, and
each of the plurality of pixel blocks has a structure in which one pixel for detecting red light, one pixel for detecting green light, one pixel for detecting blue light, and one pixel for detecting infrared are arranged in a 2-row by 2-column pixel pattern.

8. The information processing apparatus according to claim 6,
wherein each of the plurality of image sensors has a structure in which a plurality of first pixel blocks and a plurality of second pixel blocks are periodically arranged in a two-dimensional direction,
each of the plurality of first pixel blocks has a structure in which one pixel for detecting red light, one pixel for detecting green light, and two pixels for detecting infrared are arranged in a 2-row by 2-column pixel pattern, and
each of the plurality of second pixel blocks has a structure in which one pixel for detecting green light, one pixel for detecting blue light, and two pixels for detecting infrared are arranged in a 2-row by 2-column pixel pattern.

9. The information processing apparatus according to claim 6,
wherein each of the plurality of image sensors includes a plurality of pixel blocks that detects infrared, and
each of the plurality of pixel blocks that detects infrared has a structure in which a plurality of pixels that detects infrared is arranged adjacent to each other.

10. The information processing apparatus according to claim 6,
wherein each of the plurality of image sensors includes a plurality of pixel blocks arranged two-dimensionally,
each of the plurality of pixel blocks includes a plurality of pixels arranged adjacent to each other, and
each of the plurality of image sensors has a structure in which a plurality of pixel blocks to which red is allocated, a plurality of pixel blocks to which green is allocated, a plurality of pixel blocks to which blue is allocated, and a plurality of pixel blocks to which infrared are allocated are periodically arranged in a two-dimensional direction.

11. The information processing apparatus according to claim 1, comprising:
a visible light image extraction unit that extracts a visible light image using the visible light image information from the plurality of pieces of image data having different exposure periods of visible light, for each piece of image data; and
a combining unit that combines a plurality of visible light images extracted from the plurality of pieces of image data.

12. The information processing apparatus according to claim 11, comprising
a plurality of image sensors that captures each of the plurality of pieces of image data,
wherein each of the plurality of image sensors has a structure in which a plurality of pixels for detecting visible light image information and a plurality of pixels for detecting infrared image information are periodically arranged in a two-dimensional direction,
sensitivity of the plurality of image sensors to infrared is different from each other, and
the information processing apparatus comprises an exposure control unit that controls to vary exposure periods of the plurality of image sensors in accordance with the sensitivity of each of the plurality of image sensors to infrared.

13. The information processing apparatus according to claim 1,
wherein each of the plurality of pieces of image data includes information regarding a total amount of received light regarding visible light and infrared, for each pixel, as the visible light image information and the infrared image information.

14. The information processing apparatus according to claim 13, comprising
a visible light image extraction unit that separates the infrared image information and the visible light image information from each other, and extracts a visible light image from the visible light image information obtained by the separation.

15. The information processing apparatus according to claim 14,
wherein the visible light image extraction unit estimates distribution information regarding an infrared projection pattern appearing in an image, and separates the infrared image information and the visible light image information from each other based on the distribution information.

16. The information processing apparatus according to claim 15,
wherein the visible light image extraction unit extracts the visible light image from the plurality of pieces of image data having different exposure periods of visible light, for each piece of image data, and
the information processing apparatus comprises a combining unit that combines a plurality of visible light images extracted from the plurality of pieces of image data.

17. The information processing apparatus according to claim 16, comprising
a plurality of image sensors that captures each of the plurality of pieces of image data,
wherein each of the plurality of image sensors has a structure in which a plurality of pixels that detects both visible light and infrared are two-dimensionally arranged,
sensitivity of the plurality of image sensors to infrared is different from each other, and
the information processing apparatus comprises an exposure control unit that controls to vary exposure periods of the plurality of image sensors in accordance with the sensitivity of each of the plurality of image sensors to infrared.

18. The information processing apparatus according to claim 17,
wherein the visible light image extraction unit performs a correction process of correcting a color shift caused by infrared included in ambient light, the correction process being performed on the visible light image information separated from the infrared image information.

19. An information processing method to be executed by a computer, the method comprising:
acquiring a plurality of pieces of image data captured at a plurality of viewpoints, the plurality of pieces of image data each including visible light image information and infrared image information;
extracting depth information from a plurality of pieces of infrared image information included in the plurality of pieces of image data; and
processing, based on the depth information, a visible light image generated by using the visible light image information included in at least one piece of image data among the plurality of pieces of image data.

20. A program that causes a computer to execute processes comprising:
acquiring a plurality of pieces of image data captured at a plurality of viewpoints, the plurality of pieces of image data each including visible light image information and infrared image information;
extracting depth information from a plurality of pieces of infrared image information included in the plurality of pieces of image data; and
processing, based on the depth information, a visible light image generated by using the visible light image information included in at least one piece of image data among the plurality of pieces of image data.
